(19) United States
(12) Patent Application Publication
(10) Pub. No.: US 2026/0369198 A1
(43) Pub. Date: Nov. 19, 2026

(54) DISPLAY DEVICE AND ELECTRONIC DEVICE

(71) Applicant: Samsung Display Co., Ltd., Yongin-si (KR)

(72) Inventors: JUHOON KANG, Yongin-si (KR); Dahwan Lee, Yongin-si (KR); SANG-HEE JANG, Yongin-si (KR); JIYOON KIM, Yongin-si (KR); JIEUN KIM, Yongin-si (KR)

(21) Appl. No.: 19/550,595

(22) Filed: Feb. 26, 2026

(30) Foreign Application Priority Data
May 16, 2025 (KR) 10-2025-0064096

(51) Int. Cl. G09G 3/20

(52) U.S. Cl. CPC G09G 3/20; G09G 2300/0426; G09G 2300/0819; G09G 2300/0842; G09G 2300/0861; G09G 2330/02

(57) ABSTRACT

A display device includes a substrate including a plurality of display areas and a non-display, a first line disposed in a first display area among the display areas, a second line disposed in a second display area among the display areas, a first power transmission line and a second power transmission line disposed in the non-display area. The first power transmission line includes a first-first transmission line and a first-second transmission line electrically connected to the first line, and configured to transmit the first power voltage to the first line. The second power transmission line includes a second-first transmission line and a second-second transmission line electrically connected to the second line, and configured to transmit the second power voltage to the second line.

This application claims priority to Korean Patent Application 10-2025-0064096, filed on May 16, 2025, and all the benefits accruing therefrom under 35 U.S.C. § 119, the content of which in its entirety is herein incorporated by reference.

### BACKGROUND

### 1. Field

The disclosure relates to a display device and an electronic device.

### 2. Description of the Related Art

A display device includes a display panel and a driver. Pixels are arranged on the display panel, and the driver supplies signals and/or voltages to the display panel.

For example, the driver includes a data driver, a gate driver, and a power supply unit. The data driver supplies a data voltage to the display panel, the gate driver supplies a gate signal to the display panel, and the power supply unit supplies a power voltage to the display panel. The display panel emits light corresponding to the data voltage and the power voltage in response to the gate signal.

### SUMMARY

Embodiments provide a display device with improved display quality.

Other embodiments provide an electronic device including the display device. However, the purpose of the disclosure is not limited thereto purpose, and may be expanded in various ways without departing from the spirit and scope of the disclosure.

A display device according to an embodiment of the disclosure includes: a substrate, a first line, a second line, a first power transmission line, and a second power transmission line. The substrate includes a plurality of display areas, and a non-display area disposed on an outer side of the display areas. The first line is disposed in a first display area among the display areas. The first line is electrically connected to pixels disposed in the first display area. The second line is disposed in a second display area among the display areas, and electrically connected to pixels disposed in the second display area. The first power transmission line includes a first-first transmission line disposed on a first side of the non-display area, electrically connected to the first line, and configured to transmit a first power voltage to the first line, and a first-second transmission line disposed on a second side of the non-display area, electrically connected to the first line, and configured to transmit the first power voltage to the first line. The second power transmission line includes a second-first transmission line disposed on the first side of the non-display area, electrically connected to the second line, and configured to transmit a second power voltage to the second line, and a second-second transmission line disposed on the second side of the non-display area, electrically connected to the second line, and configured to transmit the second power voltage to the second line.

In an embodiment, the display device may further include a first connection line electrically connecting the first-first transmission line, the first-second transmission line, and the first line and a second connection line electrically connecting the second-first transmission line, the second-second transmission line, and the second line.

In an embodiment, each of the first connection line and the second connection line may overlap the first display area and the second display area in a plan view.

In an embodiment, the first connection line may be electrically insulated from each of the second line and the second power transmission line, and the second connection line is electrically insulated from each of the first line and the first power transmission line.

In an embodiment, the first connection line may extend from the first-first transmission line to the first-second transmission line, and the second connection line may extend from the second-first transmission line to the second-second transmission line.

In an embodiment, each of the first line and the second line may extend in a first direction, the second display area may be located in a second direction, which intersects the first direction, from the first display area, and each of the first connection line and the second connection line may extend in the second direction.

In an embodiment, each of the first-first transmission line, the first-second transmission line, the second-first transmission line, and the second-second transmission line may extend in the first direction.

In an embodiment, the first power voltage and the second power voltage may be a same power voltage.

In an embodiment, the first power voltage and the second power voltage may be different from each other.

In an embodiment, each of the first-first transmission line and the first-second transmission line may be further electrically connected to the second line, and configured to transmit the first power voltage to the second line, and each of the second-first transmission line and the second-second transmission line may be further electrically connected to the first line, and configured to transmit the second power voltage to the first line.

In an embodiment, the display device may further include: a first-first power connection line electrically connecting the first-first transmission line, the first-second transmission line, and the first line; a first-second power connection line electrically connecting the first-first transmission line, the first-second transmission line, and the second line; a second-first power connection line electrically connecting the second-first transmission line, the second-second transmission line, and the first line; and a second-second power connection line electrically connecting the second-first transmission line, the second-second transmission line, and the second line.

In an embodiment, each of the first-first power connection line, the first-second power connection line, the second-first power connection line, and the second-second power connection line may overlap the first display area and the second display area in a plan view.

In an embodiment, the first-first power connection line may be electrically insulated from each of the second line and the second power transmission line, the first-second power connection line is electrically insulated from each of the first line and the second power transmission line, the second-first power connection line is electrically insulated from each of the second line and the first power transmission line, the second-second power connection line is electrically insulated from each of the first line and the first power transmission line.

In an embodiment, each of the first-first power connection line and the first-second power connection line may extend from the first-first transmission line to the first-second transmission line, and each of the second-first power connection line and the second-second power connection line may extend from the second-first transmission line to the second-second transmission line.

In an embodiment, each of the first line and the second line may extend in a first direction, the second display area may be located in a second direction, which intersects the first direction, from the first display area, and each of the first-first power connection line, the first-second power connection line, the second-first power connection line, and the second-second power connection line may extend in the second direction.

In an embodiment, the first power voltage and the second power voltage may be different power voltages.

In an embodiment, the display device may further include: a display panel including the display areas, and the number of the display areas may be greater than or equal to the number of cycle operations of the display panel, and the number of cycle operations may be the number of light emission operations of the display panel per image frame.

In an embodiment, each of the first power transmission line and the second power transmission line may surround the display areas in a plan view.

In an embodiment, the first power transmission line and the second power transmission line may be electrically insulated from each other.

An electronic device according to an embodiment of the disclosure includes: a display device and a power supply module, which supplies power to the display device. The display device includes a substrate, a first line, a second line, a first power transmission line, and a second power transmission line. The substrate includes a plurality of display areas, and a non-display area disposed on an outer side of the display areas. The first line is disposed in a first display area among the display areas. The first line is electrically connected to pixels disposed in the first display area. The second line is disposed in a second display area among the display areas, and electrically connected to pixels disposed in the second display area. The first power transmission line includes a first-first transmission line disposed on a first side of the non-display area, electrically connected to the first line, and configured to transmit a first power voltage to the first line, and a first-second transmission line disposed on a second side of the non-display area, electrically connected to the first line, and configured to transmit the first power voltage to the first line. The second power transmission line includes a second-first transmission line disposed on the first side of the non-display area, electrically connected to the second line, and configured to transmit a second power voltage to the second line, and a second-second transmission line disposed on the second side of the non-display area, electrically connected to the second line, and configured to transmit the second power voltage to the second line.

In a display device according to embodiments of the disclosure, connection lines that provide power voltages to the display areas may be connected to power transmission lines on opposite sides (e.g., top and bottom in a plan view) of the display panel, respectively. Accordingly, a difference in voltage drop on the opposite sides (e.g., the top and bottom in a plan view) of the display area of the display panel may be effectively minimized.

In addition, in the display device according to embodiments of the disclosure, each of the connection lines that provide power voltages to the display areas may be electrically connected to one of the display areas and electrically insulated from the other display areas. Accordingly, an influence of the voltage drop due to a light-emitting operation of one display area on other display areas during a cycle operation of the display panel may be effectively minimized.

### BRIEF DESCRIPTION OF THE DRAWINGS

FIG. 1 is a plan view illustrating a display device according to an embodiment of the disclosure.

FIG. 2 is a block view illustrating the display device of FIG. 1.

FIG. 3 is a circuit diagram showing a pixel included in the display device of FIG. 1.

FIG. 4 is a plan view showing a display panel included in the display device of FIG. 1.

FIG. 5 is a block diagram showing a display device according to an embodiment of the disclosure.

FIG. 6 is a plan view showing a display panel included in the display device of FIG. 5.

FIG. 7 is a block diagram showing a display device according to an embodiment of the disclosure.

FIG. 8 is a plan view showing a display panel included in the display device of FIG. 7.

FIG. 9 is an enlarged plan view showing an area A of FIG. 8.

FIG. 10 is a block diagram showing a display device according to an embodiment of the disclosure.

FIG. 11 is a plan view showing a display panel included in the display device of FIG. 10.

FIG. 12 is an enlarged plan view showing an area B of FIG. 11.

FIG. 13 is a block diagram of an electronic device according to an embodiment.

FIG. 14 is a schematic diagram of an electronic device according to various embodiments.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “first-first,” “first-second” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

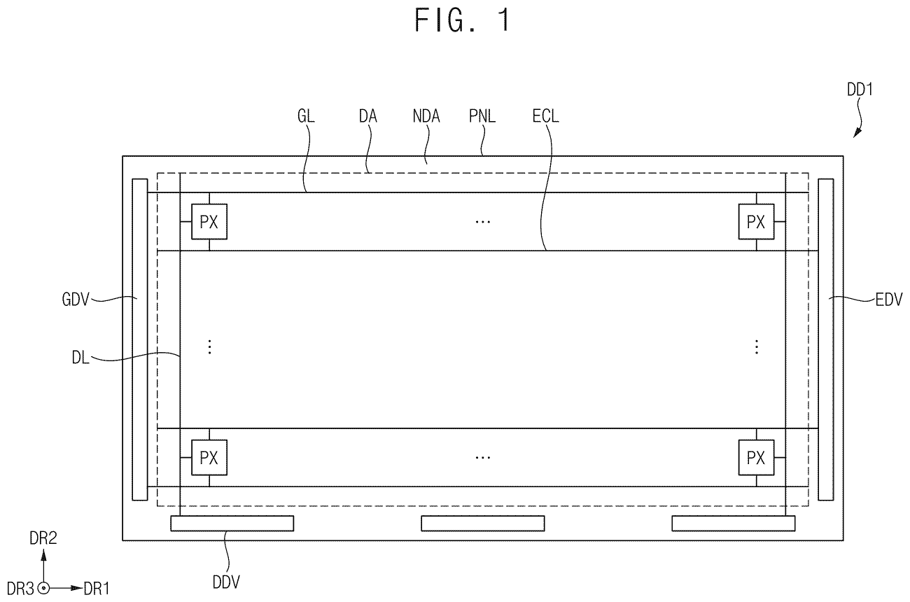

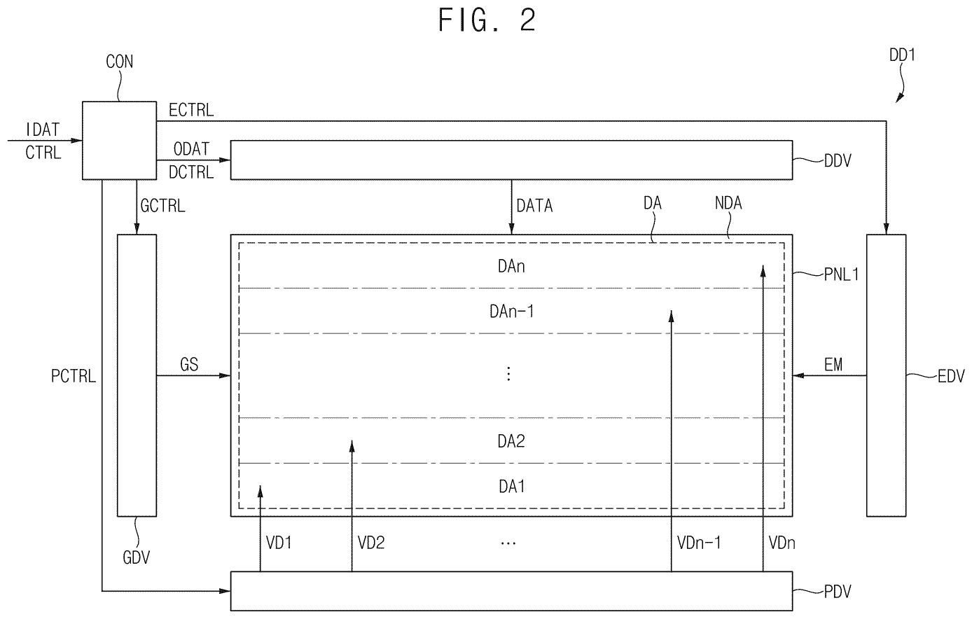

FIG. 1 is a plan view illustrating a display device according to an embodiment of the disclosure. FIG. 2 is a block view illustrating the display device of FIG. 1. As used herein, the “plan view” of the display device is a view in a thickness direction (i.e., third direction DR3) of the display device.

Referring to FIGS. 1 and 2, a display device DD1 may include a display panel PNL1, and a driver configured to drive the display panel PNL1. The display panel PNL1 may include a display area DA and a non-display area NDA.

The display area DA may be an area capable of displaying an image. A plurality of pixels PX may be arranged in the display area DA. For example, the pixels PX may be repeatedly arranged in a first direction DR1 and a second direction DR2 intersecting the first direction DR1. Each of the pixels PX may emit light so that the display area DA may display an image. For example, the display area DA may display an image in a third direction DR3 intersecting each of the first direction DR1 and the second direction DR2.

The display area DA may include a plurality of display areas. For example, the display area DA may be partitioned into n display areas (where n is a natural number that is greater than or equal to 2), which are first to n^{th} display areas DA1, . . . , and DAn. For example, the first to n^{th} display areas DA1, . . . , and DAn may be arranged in one direction (e.g., the second direction DR2), but the disclosure is not limited thereto. The pixels PX may be arranged in each of the first to n^{th} display areas DA1, . . . , and DAn, and each of the first to n^{th} display areas DA1, . . . , and DAn may display an image.

The non-display area NDA may be an area that does not display an image. The non-display area NDA may be located on an outer side of the display area DA. For example, the non-display area NDA may surround the display area DA in a plan view. The driver may be disposed in the non-display area NDA. For example, the driver may provide signals and/or voltages to the pixels PX. For example, the driver may include a gate driver GDV, an emission driver EDV, a data driver DDV, a power supplier PDV, and a controller CON.

Each of the pixels PX may be electrically connected to the gate driver GDV, the emission driver EDV, the data driver DDV, and the power supplier PDV.

The gate driver GDV may receive a gate control signal GCTRL from the controller CON. The gate driver GDV may generate a gate signal GS based on the gate control signal GCTRL. The gate signal GS may be provided to each of the pixels PX through a gate line GL.

The emission driver EDV may receive an emission control signal ECTRL from the controller CON. The emission driver EDV may generate an emission signal EM based on the emission control signal ECTRL. The emission signal EM may be provided to each of the pixels PX through an emission control line ECL.

The data driver DDV may receive a data control signal DCTRL and output image data ODAT from the controller CON. The data driver DDV may generate a data voltage DATA based on the data control signal DCTRL and the output image data ODAT. The data voltage DATA may be provided to each of the pixels PX through a data line DL.

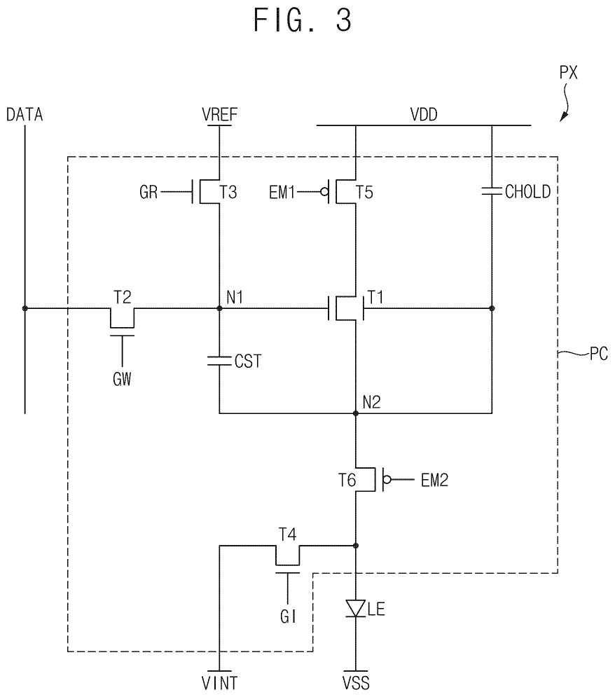

The power supplier PDV may receive a power driving control signal PCTRL from the controller CON. The power supplier PDV may generate power voltages (e.g., a high power voltage VDD, a reference voltage VREF, an initialization voltage VINT, a low power voltage VSS, and the like of FIG. 3) based on the power driving control signal PCTRL.

According to an embodiment, at least one of the power voltages may be provided to the first to n^{th} display areas DA1, . . . , and DAn as a different power voltage. At least one of the power voltages may be divided into first to n^{th} power voltages VD1, . . . , and VDn, and the first to n^{th} power voltages VD1, . . . , and VDn may be provided to the first to n^{th} display areas DA1, . . . , and DAn, respectively. For example, the first power voltage VD1 may be provided to the pixels PX arranged in the first display area DA1, the second power voltage VD2 may be provided to the pixels PX arranged in the second display area DA2, the (n−1)^{th} power voltage VDn−1 may be provided to the pixels PX arranged in the (n−1)^{th} display area DAn−1, and the n^{th} power voltage VDn may be provided to the pixels PX arranged in the n^{th} display area DAn. In this case, the first to n^{th} power voltages VD1, . . . , and VDn may be different from each other or identical to each other, and at least one of the first to n^{th} power voltages VD1, . . . , and VDn may be different.

The controller CON may receive a control signal CTRL and input image data IDAT from an external device. The controller CON may generate the gate control signal GCTRL, the emission control signal ECTRL, the data control signal DCTRL, the output image data ODAT, and the power driving control signal PCTRL based on the control signal CTRL and the input image data IDAT. The controller CON may control the gate driver GDV, the emission driver EDV, the data driver DDV, and the power supplier PDV.

Although it has been shown in FIG. 1 that the gate driver GDV is disposed on a first side of the display device DD1, and the emission driver EDV is disposed on a second side of the display device DD1, the disclosure is not limited thereto. For example, the gate driver GDV and the emission driver EDV may be disposed together on the first side or the second side of the display device DD1. For another example, the gate driver GDV and the emission driver EDV may be formed integrally with each other.

FIG. 3 is a circuit diagram showing a pixel included in the display device of FIG. 1.

Referring to FIGS. 2 and 3, each of the pixels PX included in the display device DD1 may include a pixel circuit PC and a light emitting element LE. The pixel circuit PC may generate a driving current, and may be electrically connected to the light emitting element LE. The light emitting element LE may generate light corresponding to the driving current.

The pixel circuit PC may include a first transistor T1, a second transistor T2, a third transistor T3, a fourth transistor T4, a fifth transistor T5, a sixth transistor T6, a first capacitor CST, and a second capacitor CHOLD.

The first transistor T1 may include a gate terminal connected to a first node N1, a first terminal connected to the fifth transistor T5, and a second terminal connected to a second node N2. The first transistor T1 may generate the driving current based on a voltage difference between the gate terminal and the first terminal. The first transistor T1 may further include a back gate terminal connected to the second capacitor CHOLD. Since the back gate terminal of the first transistor T1 is connected to the second capacitor CHOLD, the back gate terminal may be maintained at a constant voltage so that driving characteristics of the first transistor T1 may be improved.

The second transistor T2 may include a gate terminal configured to receive a first gate signal GW, a first terminal configured to receive the data voltage DATA, and a second terminal connected to the first node N1. The second transistor T2 may transmit the data voltage DATA to the first node N1 in response to the first gate signal GW.

The third transistor T3 may include a gate terminal configured to receive a second gate signal GR, a first terminal configured to receive a reference voltage VREF, and a second terminal connected to the first node N1. The third transistor T3 may transmit the reference voltage VREF to the first node N1 in response to the second gate signal GR.

The fourth transistor T4 may include a gate terminal configured to receive a third gate signal GI, a first terminal configured to receive an initialization voltage VINT, and a second terminal connected to the light emitting element LE. The fourth transistor T4 may transmit the initialization voltage VINT to a first terminal of the light emitting element LE in response to the third gate signal GI.

The fifth transistor T5 may include a gate terminal configured to receive a first emission signal EM1, a first terminal configured to receive a high power voltage VDD, and a second terminal connected to the first transistor T1. The fifth transistor T5 may transmit the high power voltage VDD to the first terminal of the first transistor T1 in response to the first emission signal EM1.

The sixth transistor T6 may include a gate terminal configured to receive a second emission signal EM2, a first terminal connected to the second node N2, and a second terminal connected to the light emitting element LE. The sixth transistor T6 may connect the second node N2 and the first terminal of the light emitting element LE in response to the second emission signal EM2.

The first capacitor CST may include a first terminal connected to the first node N1, and a second terminal connected to the second node N2. The second capacitor CHOLD may include a first terminal configured to receive the high power voltage VDD, and a second terminal connected to the second node N2.

The light emitting element LE may include the first terminal connected to the fourth and sixth transistors T4 and T6, and a second terminal configured to receive a low power voltage VSS. A voltage level of the low power voltage VSS may be lower than a voltage level of the high power voltage VDD. The light emitting element LE may emit light based on the driving current generated by the first transistor T1.

According to an embodiment, one of the power voltages received by the pixel circuit PC may be the first to n^{th} power voltages VD1, . . . , and VDn.

According to an embodiment, the high power voltage VDD may be one of the first to n^{th} power voltages VD1, . . . , and VDn received by the pixel circuit PC from the power supplier PDV. For example, when the pixel PX is disposed in the first display area DA1, the high power voltage VDD may be the first power voltage VD1. When the pixel PX is disposed in the second display area DA2, the high power voltage VDD may be the second power voltage VD2. When the pixel PX is disposed in the (n−1)^{th} display area DAn−1, the high power voltage VDD may be the (n−1)^{th} power voltage VDn−1. When the pixel PX is disposed in the n^{th} display area DAn, the high power voltage VDD may be the n^{th} power voltage VDn.

However, the disclosure is not limited thereto, and according to an embodiment, other voltages (e.g., the reference voltage VREF, the initialization voltage VINT, or the low power voltage VSS) received by the pixel circuit PC may be the first to n^{th} power voltages VD1, . . . , and VDn. For example, when the pixel PX is disposed in the first display area DA1, the reference voltage VREF, the initialization voltage VINT, or the low power voltage VSS may be the first power voltage VD1. When the pixel PX is disposed in the second display area DA2, the reference voltage VREF, the initialization voltage VINT, or the low power voltage VSS may be the second power voltage VD2. When the pixel PX is arranged in the (n−1)^{th} display area DAn−1, the reference voltage VREF, the initialization voltage VINT, or the low power voltage VSS may be the (n−1)^{th} power voltage VDn−1. When the pixel PX is arranged in the n^{th} display area DAn, the reference voltage VREF, the initialization voltage VINT, or the low power voltage VSS may be the n^{th} power voltage VDn.

Although it has been shown in FIG. 3 that the first to fourth transistors T1, T2, T3, and T4 are implemented as N-type metal oxide semiconductor (NMOS) transistors, and the fifth and sixth transistors T5 and T6 are implemented as P-type metal oxide semiconductor (PMOS) transistors, the disclosure is not limited thereto. At least one of the first to sixth transistors T1, T2, T3, T4, T5, and T6 may be implemented as an NMOS transistor, or at least one of the first to sixth transistors T1, T2, T3, T4, T5, and T6 may be implemented as a PMOS transistor.

Although the pixel circuit PC has been shown in FIG. 3 as having a 6T2C structure including the first to sixth transistors T1, T2, T3, T4, T5, and T6 and the first and second capacitors CST and CHOLD, the disclosure is not limited thereto. The pixel circuit PC may have any structure including at least one transistor and at least one capacitor.

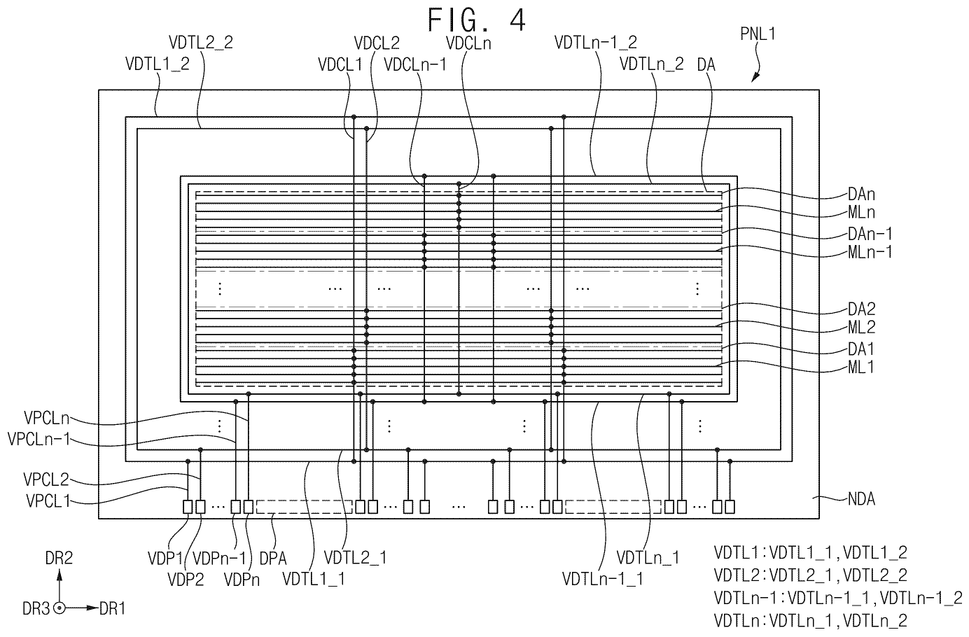

FIG. 4 is a plan view showing a display panel included in the display device of FIG. 1.

Referring to FIGS. 2, 3, and 4, the display panel PNL1 may include the display area DA including the first to n^{th} display areas DA1, . . . , and DAn, and the non-display area NDA.

The display panel PNL1 may include first to n^{th} lines ML1, . . . , and MLn arranged in the display area DA. The first to n^{th} lines ML1, . . . , and MLn may be arranged in the first to n^{th} display areas DA1, . . . , and DAn, respectively. Each of the first to n^{th} lines ML1, . . . , and MLn may extend in a horizontal direction (e.g., the first direction DR1 or a pixel row direction). Each of the first to n^{th} lines ML1, . . . , and MLn may include a plurality of lines extending in the first direction DR1. The first to n^{th} lines ML1, . . . , and MLn may be spaced apart from each other, and electrically insulated from each other.

For example, the first line ML1 may be disposed in the first display area DA1, and may extend in the first direction DR1. The second line ML2 may be disposed in the second display area DA2, and may extend in the first direction DR1. The (n−1)^{th} line MLn−1 may be disposed in the (n−1)^{th} display area DAn−1, and may extend in the first direction DR1. The n^{th} line MLn may be disposed in the n^{th} display area DAn, and may extend in the first direction DR1.

The first to n^{th} lines ML1, . . . , and MLn may receive the first to n^{th} power voltages VD1, . . . , and VDn from the power supplier PDV, respectively. In addition, the first to n^{th} lines ML1, . . . , and MLn may be electrically connected to the pixels PX arranged in corresponding display areas, and may transmit the first to n^{th} power voltages VD1, . . . , and VDn to the pixels PX, respectively. For example, the first line ML1 may provide the first power voltage VD1 to the pixels PX arranged in the first display area DA1. The second line ML2 may provide the second power voltage VD2 to the pixels PX arranged in the second display area DA2. The (n−1)^{th} line MLn−1 may provide the (n−1)^{th} power voltage VDn−1 to the pixels PX arranged in the (n−1)^{th} display area DAn−1. The n^{th} line MLn may provide the n^{th} power voltage VDn to the pixels PX arranged in the n^{th} display area DAn.

The display panel PNL1 may include a plurality of pads and a plurality of transmission lines, which are arranged in the non-display area NDA.

The non-display area NDA may include a data pad area DPA in which a plurality of data pads spaced apart from each other are arranged. Each of the data pads may receive the data voltage DATA from the data driver DDV. For example, as shown in FIG. 4, the non-display area NDA may include a plurality of data pad areas DPA spaced apart from each other in the first direction DR1.

According to an embodiment, the display panel PNL1 may include first to n^{th} power pads VDP1, . . . , and VDPn. The first to n^{th} power pads VDP1, . . . , and VDPn may receive the first to n^{th} power voltages VD1, . . . , and VDn from the power supplier PDV, respectively.

For example, as shown in FIG. 4, the first to n^{th} power pads VDP1, . . . , and VDPn may be arranged on each of both sides (e.g., both sides in the first direction DR1) of the data pad area DPA. For example, the first to n^{th} power pads VDP1, . . . , and VDPn may be sequentially arranged in the first direction DR1 on one side of the data pad area DPA, and the first to n^{th} power pads VDP1, . . . , and VDPn may be sequentially arranged in a direction that is opposite to the first direction DR1 on an opposite side of the data pad area DPA. For example, the first to n^{th} power pads VDP1, . . . , and VDPn may be symmetrically arranged in the first direction DR1 based on the data pad area DPA, but the disclosure is not limited thereto.

According to an embodiment, the display panel PNL1 may include first to n^{th} power transmission lines VDTL1, . . . , and VDTLn. The first to n^{th} power transmission lines VDTL1, . . . , and VDTLn may be spaced apart from each other, and electrically insulated from each other.

Each of the first to n^{th} power transmission lines VDTL1, . . . , and VDTLn may include a plurality of transmission lines spaced apart from each other and extending in a horizontal direction (e.g., the first direction DR1 or the pixel row direction). The transmission lines of each of the first to n^{th} power transmission lines VDTL1, . . . , and VDTLn may be arranged on both sides (e.g., both sides in the second direction DR2) of the display panel PNL1, respectively. The transmission lines of each of the first to n^{th} power transmission lines VDTL1, . . . , and VDTLn may be electrically connected to each other. For example, each of the first to n^{th} power transmission lines VDTL1, . . . , and VDTLn may extend continuously, and surround the display area DA in a plan view.

According to an embodiment, the first power transmission line VDTL1 may include a first-first transmission line VDTL1_1 and a first-second transmission line VDTL1_2, which are spaced apart from each other, and each of the first-first transmission line VDTL1_1 and the first-second transmission line VDTL1_2 may extend in the first direction DR1. For example, the first-first transmission line VDTL1_1 may be disposed in the non-display area NDA on a first side of the display panel PNL1 (e.g., at a lower end of the display panel PNL1 in a plan view), the first-second transmission line VDTL1_2 may be disposed in the non-display area NDA on a second side that is opposite to the first side of the display panel PNL1 (e.g., at an upper end of the display panel PNL1 in a plan view), and the first-second transmission line VDTL1_2 may be spaced apart from the first-first transmission line VDTL1_1 in the second direction DR2. According to an embodiment, the first-first and first-second transmission lines VDTL1_1 and VDTL1_2 may be electrically connected to each other by additional connection lines connecting ends of the first-first and first-second transmission lines VDTL1_1 and VDTL1_2 and extending in the second direction DR2 and disposed at right and left ends of the display panel PNL1 in the non-display area NDA, respectively. For example, the first power transmission line VDTL1 including the first-first and first-second transmission lines VDTL1_1 and VDTL1_2 and the additional connection lines may extend continuously, and surround the display area DA in a plan view.

According to an embodiment, the second power transmission line VDTL2 may include a second-first transmission line VDTL2_1 and a second-second transmission line VDTL2_2, which are spaced apart from each other, and each of the second-first transmission line VDTL2_1 and the second-second transmission line VDTL2_2 may extend in the first direction DR1. For example, the second-first transmission line VDTL2_1 may be disposed in the non-display area NDA on the first side of the display panel PNL1 (e.g., at a lower end of the display panel PNL1 in a plan view), the second-second transmission line VDTL2_2 may be disposed in the non-display area NDA on the second side of the display panel PNL1 (e.g., at an upper end of the display panel PNL1 in a plan view), and the second-second transmission line VDTL2_2 may be spaced apart from the second-first transmission line VDTL2_1 in the second direction DR2. For example, the second-first transmission line VDTL2_1 may be adjacent to the first-first transmission line VDTL1_1 in the second direction DR2, and the second-second transmission line VDTL2_2 may be adjacent to the first-second transmission line VDTL1_2 in a direction that is opposite to the second direction DR2. According to an embodiment, the second-first and second-second transmission lines VDTL2_1 and VDTL2_2 may be electrically connected to each other by additional connection lines connecting ends of the second-first and second-second transmission lines VDTL2_1 and VDTL2_2 and extending in the second direction DR2 and disposed at right and left ends of the display panel PNL1 in the non-display area NDA, respectively. For example, the second power transmission line VDTL2 including the second-first and second-second transmission lines VDTL2_1 and VDTL2_2 and the additional connection lines may extend continuously, and surround the display area DA in a plan view. For example, the second power transmission line VDTL2 may be arranged between the first power transmission line VDTL1 and the display area DA in a plan view.

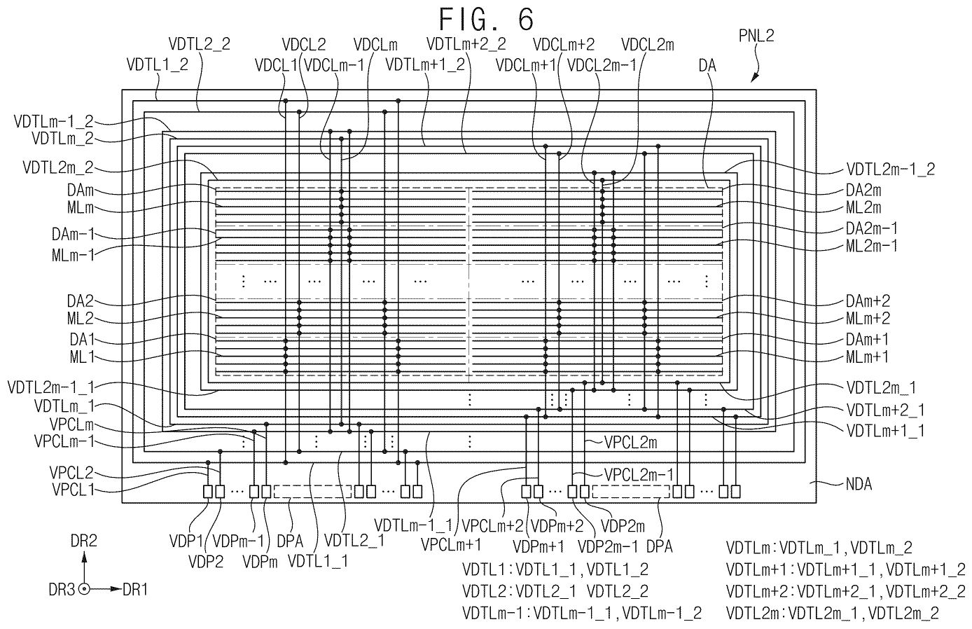

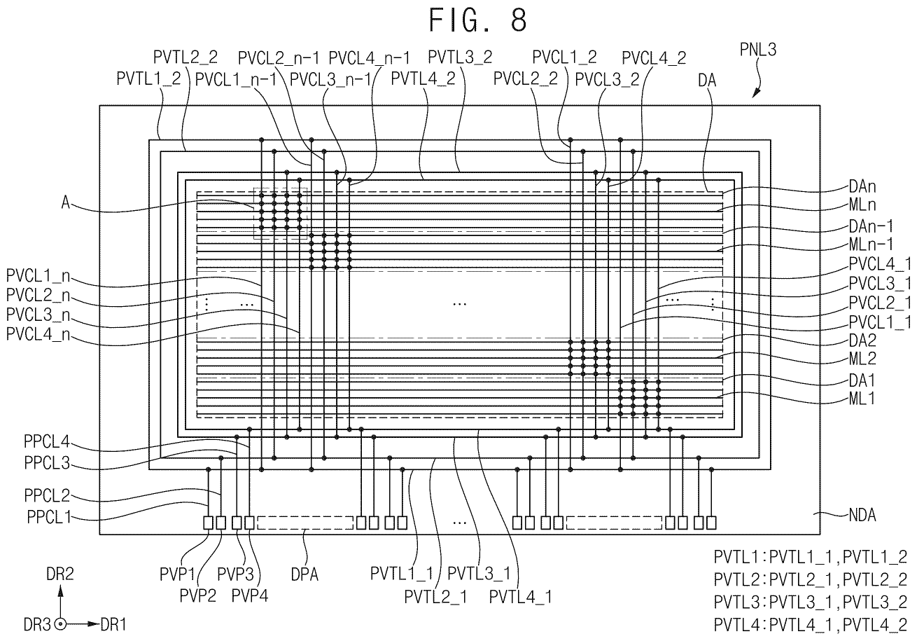

According to an embodiment, the (n−1)^{th} power transmission line VDTLn−1 may include an (n−1)^{th}-first transmission line VDTLn−1_1 and an (n−1)^{th}-second transmission line VDTLn−1_2, which are spaced apart from each other, and each of the (n−1)^{th}-first transmission line VDTLn−1_1 and the (n−1)^{th}-second transmission line VDTLn−1_2 may extend in the first direction DR1. For example, the (n−1)^{th}-first transmission line VDTLn−1_1 may be disposed in the non-display area NDA on the first side of the display panel PNL1, the (n−1)^{th}-second transmission line VDTLn−1_2 may be disposed in the non-display area NDA on the second side of the display panel PNL1, and the (n−1)^{th}-second transmission line VDTLn−1_2 may be spaced apart from the (n−1)^{th}-first transmission line VDTLn−1_1 in the second direction DR2. For example, the (n−1)^{th}-first transmission line VDTLn−1_1 may be adjacent to the (n−2)^{th}-first transmission line in the second direction DR2, and the (n−1)^{th}-second transmission line VDTLn−1_2 may be adjacent to the (n−2)^{th}-second transmission line in the direction that is opposite to the second direction DR2. According to an embodiment, the (n−1)^{th}-first and (n−1)^{th}-second transmission lines VDTLn−1_1 and VDTLn−1_2 may be electrically connected to each other by additional connection lines connecting ends of the (n−1)^{th}-first and (n−1)^{th}-second transmission lines VDTLn−1_1 and VDTLn−1_2 and extending in the second direction DR2 and disposed at right and left ends of the display panel PNL1 in the non-display area NDA. For example, the (n−1)^{th} power transmission line VDTLn−1 including the (n−1)^{th}-first and (n−1)^{th}-second transmission lines VDTLn−1_1 and VDTLn−1_2 and the additional connection lines may extend continuously, and surround the display area DA in a plan view. For example, the (n−1)^{th} power transmission line VDTLn−1 may be arranged between the (n−2)^{th} power transmission line and the display area DA in a plan view. Such additional connection lines also exist in the embodiments of FIGS. 6 and 8 below.

According to an embodiment, the n^{th} power transmission line VDTLn may include an n^{th}-first transmission line VDTLn_1 and an n^{th}-second transmission line VDTLn_2, which are spaced apart from each other, and each of the n^{th}-first transmission line VDTLn_1 and the n^{th}-second transmission line VDTLn_2 may extend in the first direction DR1. For example, the n^{th}-first transmission line VDTLn_1 may be disposed in the non-display area NDA on the first side of the display panel PNL1, the n^{th}-second transmission line VDTLn_2 may be disposed in the non-display area NDA on the second side of the display panel PNL1, and the n^{th}-second transmission line VDTLn_2 may be spaced apart from the n^{th}-first transmission line VDTLn_1 in the second direction DR2. For example, the n^{th}-first transmission line VDTLn_1 may be adjacent to the (n−1)^{th}-first transmission line VDTLn−1_1 in the second direction DR2, and the n^{th}-second transmission line VDTLn_2 may be adjacent to the (n−1)^{th}-second transmission line VDTLn−1_2 in the direction that is opposite to the second direction DR2. According to an embodiment, the n^{th}-first and n^{th}-second transmission lines VDTLn_1 and VDTLn_2 may be electrically connected to each other. For example, the n^{th} power transmission line VDTLn including the n^{th}-first and n^{th}-second transmission lines VDTLn_1 and VDTLn_2 may extend continuously, and surround the display area DA in a plan view. For example, the n^{th} power transmission line VDTLn may be arranged between the (n−1)^{th} power transmission line VDTLn−1 and the display area DA in a plan view.

The display panel PNL1 may include a plurality of power pad connection lines arranged in the non-display area NDA, and electrically connecting the first to n^{th} power pads VDP1, . . . , and VDPn to the first to n^{th} power transmission lines VDTL1, . . . , and VDTLn.

According to an embodiment, the first to n^{th} power transmission lines VDTL1, . . . , and VDTLn may be electrically connected to the first to n^{th} power pads VDP1, . . . , and VDPn through first to n^{th} power pad connection lines VPCL1, . . . , and VPCLn, respectively. For example, each of the first to n^{th} power pad connection lines VPCL1, . . . , and VPCLn may extend in the second direction DR2.

For example, the first power transmission line VDTL1 may be electrically connected to the first power pad VDP1 through the first power pad connection line VPCL1. The second power transmission line VDTL2 may be electrically connected to the second power pad VDP2 through the second power pad connection line VPCL2. The (n−1)^{th} power transmission line VDTLn−1 may be electrically connected to the (n−1)^{th} power pad VDPn−1 through the (n−1)^{th} power pad connection line VPCLn−1. The n^{th} power transmission line VDTLn may be electrically connected to the n^{th} power pad VDPn through the n^{th} power pad connection line VPCLn. Accordingly, the first to n^{th} power transmission lines VDTL1, . . . , and VDTLn may receive the first to n^{th} power voltages VD1, . . . , and VDn, respectively.

The display panel PNL1 may include a plurality of connection lines electrically connecting the first to n^{th} power transmission lines VDTL1, . . . , and VDTLn to the first to n^{th} lines ML1, . . . , and MLn.

According to an embodiment, the first to n^{th} power transmission lines VDTL1, . . . , and VDTLn may be electrically connected to the first to n^{th} lines ML1, . . . , and MLn through first to n^{th} connection lines VDCL1, . . . , and VDCLn, respectively. Each of the first to n^{th} connection lines VDCL1, . . . , and VDCLn may extend in a vertical direction (e.g., the second direction DR2 or a pixel column direction). In a plan view, the first to n th connection lines VDCL1, . . . , and VDCLn may intersect the first to n^{th} lines ML1, . . . , and MLn, and overlap the first to n^{th} display areas DA1, . . . , and DAn. The first to n^{th} connection lines VDCL1, . . . , and VDCLn may be connected to each of the transmission lines, which are included in each of the first to n^{th} power transmission lines VDTL1, . . . , and VDTLn. In other words, each of the first to n^{th} connection lines VDCL1, . . . , and VDCLn may extend from the non-display area NDA on the first side, traverse the display area DA, and extend to the non-display area NDA on the second side.

The first connection line VDCL1 may electrically connect the first power transmission line VDTL1 disposed in the non-display area NDA to the first line ML1 disposed in the first display area DA1. According to an embodiment, the first connection line VDCL1 may extend in the second direction DR2, and may be electrically connected to each of the first-first transmission line VDTL1_1 and the first-second transmission line VDTL1_2.

The first connection line VDCL1 may be electrically connected to each of the first-first and first-second transmission lines VDTL1_1 and VDTL1_2 through a contact hole, and electrically insulated from the second to n^{th} power transmission lines VDTL2, . . . , and VDTLn. The first connection line VDCL1 may be electrically connected to the first line ML1 of the first display area DA1 through a contact hole, and electrically insulated from the second to n^{th} lines ML2, . . . , and MLn. The first connection line VDCL1 may overlap the first to n^{th} display areas DA1, . . . , and DAn (i.e., the first to n^{th} lines ML1, . . . , and MLn) in a plan view.

Accordingly, the first power voltage VD1 may be transmitted to the pixels PX, which are arranged in the first display area DA1 and connected to the first line ML1, through the first power pad VDP1, the first power pad connection line VPCL1, the first power transmission line VDTL1 (i.e., the first-first and first-second transmission lines VDTL1_1 and VDTL1_2), and the first connection line VDCL1.

The second connection line VDCL2 may electrically connect the second power transmission line VDTL2 disposed in the non-display area NDA to the second line ML2 disposed in the second display area DA2. According to an embodiment, the second connection line VDCL2 may extend in the second direction DR2, and may be electrically connected to each of the second-first transmission line VDTL2_1 and the second-second transmission line VDTL2_2.

The second connection line VDCL2 may be electrically connected to each of the second-first and second-second transmission lines VDTL2_1 and VDTL2_2 through a contact hole, and electrically insulated from the first power transmission line VDTL1 and the third to n^{th} power transmission lines VDTL3, . . . , and VDTLn. The second connection line VDCL2 may be electrically connected to the second line ML2 of the second display area DA2 through a contact hole, and electrically insulated from the first line ML1 and the third to n^{th} lines ML3, . . . , and MLn. The second connection line VDCL2 may overlap the first to n^{th} display areas DA1, . . . , and DAn (i.e., the first to n^{th} lines ML1, . . . , and MLn) in a plan view.

Accordingly, the second power voltage VD2 may be transmitted to the pixels PX, which are arranged in the second display area DA2 and connected to the second line ML2, through the second power pad VDP2, the second power pad connection line VPCL2, the second power transmission line VDTL2 (i.e., the second-first and second-second transmission lines VDTL2_1 and VDTL2_2), and the second connection line VDCL2.

The (n−1)^{th} connection line VDCLn−1 may electrically connect the (n−1)^{th} power transmission line VDTLn−1 disposed in the non-display area NDA to the (n−1)^{th} line MLn−1 disposed in the (n−1)^{th} display area DAn−1. According to an embodiment, the (n−1)^{th} connection line VDCLn−1 may extend in the second direction DR2, and may be electrically connected to each of the (n−1)^{th}-first transmission line VDTLn−1_1 and the (n−1)^{th}-second transmission line VDTLn−1_2.

The (n−1)^{th} connection line VDCLn−1 may be electrically connected to each of the (n−1)^{th}-first and (n−1)^{th}-second transmission lines VDTLn−1_1 and VDTLn−1_2 through a contact hole, and electrically insulated from the first to (n−2)^{th} power transmission lines VDTL1, . . . , and VDTLn−2 and the n^{th} power transmission line VDTLn. The (n−1)^{th} connection line VDCLn−1 may be electrically connected to the (n−1)^{th} line MLn−1 of the (n−1)^{th} display area DAn−1 through a contact hole, and electrically insulated from the first to (n−2)^{th} lines ML1, . . . , and MLn−2 and the n^{th} line MLn. The (n−1)^{th} connection line VDCLn−1 may overlap the first to n^{th} display areas DA1, . . . , and DAn (i.e., the first to n^{th} lines ML1, . . . , and MLn) in a plan view.

Accordingly, the (n−1)^{th} power voltage VDn−1 may be transmitted to the pixels PX, which are arranged in the (n−1)^{th} display area DAn−1 and connected to the (n−1)^{th} line MLn−1, through the (n−1)^{th} power pad VDPn−1, the (n−1)^{th} power pad connection line VPCLn−1, the (n−1)^{th} power transmission line VDTLn−1 (i.e., the (n−1)^{th}-first and (n−1)^{th}-second transmission lines VDTLn−1_1 and VDTLn−1_2), and the (n−1)^{th} connection line VDCLn−1.

The n^{th} connection line VDCLn may electrically connect the n^{th} power transmission line VDTLn disposed in the non-display area NDA to the n^{th} line MLn disposed in the n^{th} display area DAn. According to an embodiment, the n^{th} connection line VDCLn may extend in the second direction DR2, and may be electrically connected to each of the n^{th}-first transmission line VDTLn_1 and the n^{th}-second transmission line VDTLn_2.

The n^{th} connection line VDCLn may be electrically connected to each of the n^{th} first and nth-second transmission lines VDTLn_1 and VDTLn_2 through a contact hole, and electrically insulated from the first to (n−1)^{th} power transmission lines VDTL1, . . . , and VDTLn−1. The n^{th} connection line VDCLn may be electrically connected to the n^{th} line MLn of the n^{th} display area DAn through a contact hole, and electrically insulated from the first to (n−1)^{th} lines ML1, . . . , and MLn−1. The n^{th} connection line VDCLn may overlap the first to n^{th} display areas DA1, . . . , and DAn (i.e., the first to n^{th} lines ML1, . . . , and MLn) in a plan view.

Accordingly, the n^{th} power voltage VDn may be transmitted to the pixels PX, which are arranged in the n^{th} display area DAn and connected to the n^{th} line MLn, through the n^{th} power pad VDPn, the n^{th} power pad connection line VPCLn, the n^{th} power transmission line VDTLn (i.e., the n^{th}-first and n^{th}-second transmission lines VDTLn_1 and VDTLn_2), and the n^{th} connection line VDCLn.

According to the display device DD1 of an embodiment of the disclosure, a plurality of power voltages may be provided to a plurality of display areas, respectively, and connection lines configured to provide the power voltages may be connected to power transmission lines, respectively, on both sides (e.g., at upper and lower ends in a plan view) of the display panel PNL1. Accordingly, a voltage drop difference between both sides (e.g., upper and lower ends in a plan view) of the display area DA of the display panel PNL1 may be minimized, and display quality of the display device DD1 may be effectively improved.

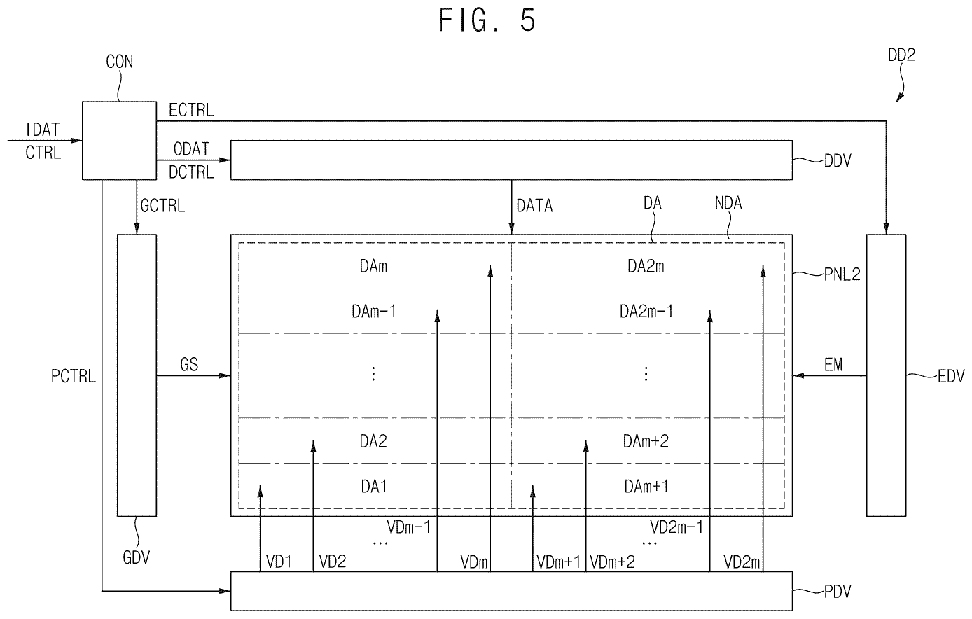

FIG. 5 is a block diagram showing a display device according to an embodiment of the disclosure. Unlike the display device DD1 described with reference to FIGS. 1 to 4, in which the display area DA is partitioned only in a pixel column direction (e.g., a second direction DR2 of FIG. 6), according to a display device DD2 that will be described with reference to FIG. 5, a display area DA may be partitioned in both a pixel row direction (e.g., a first direction DR1 of FIG. 6) and the pixel column direction.

Hereinafter, redundant descriptions corresponding to the display device DD1 described with reference to FIGS. 1 to 4 will be omitted or simplified.

Referring to FIG. 5, the display device DD2 may include a display panel PNL2, and a driver configured to drive the display panel PNL2. The display panel PNL2 may include a display area DA in which a plurality of pixels are arranged, and a non-display area NDA in which the driver is disposed. For example, the driver may provide signals and/or voltages to the pixels, and may include a gate driver GDV, an emission driver EDV, a data driver DDV, a power supplier PDV, and a controller CON.

The display area DA may include a plurality of display areas. For example, the display area DA may be partitioned into 2m display areas (where m is a natural number that is greater than or equal to 2), which are first to 2m^{th} display areas DA1, . . . , and DA2m. For example, m display areas, which are the first to m^{th} display areas DA1, . . . , and DAm, may be arranged on the left half of the display panel PNL2, and m display areas, which are (m+1)^{th} to 2m^{th} display areas DAm+1, . . . , and DA2m, may be arranged on the right half of the display panel PNL2. The first to m^{th} display areas DA1, . . . , and DAm may be arranged in one direction (e.g., the second direction DR2 of FIG. 6), and the (m+1)^{th} to 2m^{th} display areas DAm+1, . . . , and DA2m may be arranged in the one direction, but the disclosure is not limited thereto. The pixels may be arranged in each of the first to 2m^{th} display areas DA1, . . . , and DA2m, and each of the first to 2m^{th} display areas DA1, . . . , and DA2m may display an image.

According to an embodiment, different power voltages may be provided to the first to 2m^{th} display areas DA1, . . . , and DA2m. First to 2m^{th} power voltages VD1, . . . , and VD2m may be provided to the first to 2m^{th} display areas DA1, . . . , and DA2m, respectively. For example, the first power voltage VD1 may be provided to the pixels arranged in the first display area DA1, the second power voltage VD2 may be provided to the pixels arranged in the second display area DA2, the (m−1)^{th} power voltage VDm−1 may be provided to the pixels arranged in the (m−1)^{th} display area DAm−1, and the m^{th} power voltage VDm may be provided to the pixels PX arranged in the m^{th} display area DAm. The (m+1)^{th} power voltage VDm+1 may be provided to the pixels arranged in the (m+1)^{th} display area DAm+1, the (m+2)^{th} power voltage VDm+2 may be provided to the pixels arranged in the (m+2)^{th} display area DAm+2, the (2m−1)^{th} power voltage VD2m-1 may be provided to the pixels arranged in the (2m−1)^{th} display area DA2m-1, and the 2m^{th} power voltage VD2m may be provided to the pixels arranged in the 2m^{th} display area DA2m.

In this case, the first to 2m^{th} power voltages VD1, . . . , and VD2m may be different from each other or identical to each other, and at least one of the first to 2m^{th} power voltages VD1, . . . , and VD2m may be different.

According to an embodiment, each of the first to 2m^{th} power voltages VD1, . . . , and VD2m may be one of power voltages (e.g., a high power voltage, a low power voltage, a reference voltage, an initialization voltage, etc.) received by a pixel circuit of each of the pixels PX.

FIG. 6 is a plan view showing a display panel included in the display device of FIG. 5.

Referring to FIGS. 5 and 6, the display panel PNL2 may include the display area DA including the first to 2m^{th} display areas DA1, . . . , and DA2m, and the non-display area NDA.

The display panel PNL2 may include first to 2m^{th} lines ML1, . . . , and ML2m arranged in the first to 2m^{th} display areas DA1, . . . , and DA2m, respectively. Each of the first to 2m^{th} lines ML1, . . . , and ML2m may extend in a horizontal direction (e.g., a first direction DR1 or the pixel row direction). Each of the first to 2m^{th} lines ML1, . . . , and ML2m may include a plurality of lines extending in the first direction DR1. The first to 2m^{th} lines ML1, . . . , and ML2m may be spaced apart from each other, and electrically insulated from each other.

The first to 2m^{th} lines ML1, . . . , and ML2m may receive the first to 2m^{th} power voltages VD1, . . . , and VD2m from the power supplier PDV, respectively, and may be electrically connected to the pixels arranged in corresponding display areas so as to transmit the first to 2m^{th} power voltages VD1, . . . , and VD2m, respectively.

For example, the first line ML1 may provide the first power voltage VD1 to the pixels arranged in the first display area DA1. The second line ML2 may provide the second power voltage VD2 to the pixels PX arranged in the second display area DA2. The (m−1)^{th} line MLm−1 may provide the (m−1)^{th} power voltage VDm−1 to the pixels arranged in the (m−1)^{th} display area DAm−1. The m^{th} line MLm may provide the m^{th} power voltage VDm to the pixels arranged in the m^{th} display area DAm. The (m+1)^{th} line MLm+1 may provide the (m+1)^{th} power voltage VDm+1 to the pixels arranged in the (m+1)^{th} display area DAm+1. The (m+2)^{th} line MLm+2 may provide the (m+2)^{th} power voltage VDm+2 to the pixels arranged in the (m+2)^{th} display area DAm+2. The (2m−1)^{th} line ML2m−1 may provide the (2m−1)^{th} power voltage VD2m-1 to the pixels arranged in the (2m−1)^{th} display area DA2m-1. The 2m^{th} line ML2m may provide the 2m^{th} power voltage VD2m to the pixels arranged in the 2m^{th} display area DA2m.

The display panel PNL2 may include first to 2m^{th} power pads VDP1, . . . , and VDP2m arranged in the non-display area NDA. The first to 2m^{th} power pads VDP1, . . . , and VDP2m may receive the first to 2m^{th} power voltages VD1, . . . , and VD2m from the power supplier PDV, respectively. For example, the first to 2m^{th} power pads VDP1, . . . , and VDP2m may be arranged in the first direction DR1.

The display panel PNL2 may include first to 2m^{th} power transmission lines VDTL1, . . . , and VDTL2m arranged in the non-display area NDA. The first to 2m^{th} power transmission lines VDTL1, . . . , and VDTL2m may be spaced apart from each other, and electrically insulated from each other.

Each of the first to 2m^{th} power transmission lines VDTL1, . . . , and VDTL2m may include a plurality of transmission lines spaced apart from each other and extending in a horizontal direction (e.g., the first direction DR1 or the pixel row direction). The transmission lines of each of the first to 2m^{th} power transmission lines VDTL1, . . . , and VDTL2m may be arranged on both sides (e.g., both sides in the second direction DR2) of the display panel PNL2, respectively. The transmission lines of each of the first to 2m^{th} power transmission lines VDTL1, . . . , and VDTL2m may be electrically connected to each other. For example, each of the first to 2m^{th} power transmission lines VDTL1, . . . , and VDTL2m may extend continuously, and surround the display area DA in a plan view.

According to an embodiment, the first power transmission line VDTL1 may include a first-first transmission line VDTL1_1 and a first-second transmission line VDTL1_2, which are spaced apart from each other, and each of the first-first transmission line VDTL1_1 and the first-second transmission line VDTL1_2 may extend in the first direction DR1. For example, the first-first transmission line VDTL1_1 may be disposed in the non-display area NDA on a first side of the display panel PNL2 (e.g., at a lower end of the display panel PNL2 in a plan view), and the first-second transmission line VDTL1_2 may be disposed in the non-display area NDA on a second side that is opposite to the first side of the display panel PNL2 (e.g., at an upper end of the display panel PNL2 in a plan view). According to an embodiment, the first-first and first-second transmission lines VDTL1_1 and VDTL1_2 may be electrically connected to each other. For example, the first power transmission line VDTL1 including the first-first and first-second transmission lines VDTL1_1 and VDTL1_2 may extend continuously, and surround the display area DA in a plan view.

According to an embodiment, the second power transmission line VDTL2 may include a second-first transmission line VDTL2_1 and a second-second transmission line VDTL2_2, which are spaced apart from each other, and each of the second-first transmission line VDTL2_1 and the second-second transmission line VDTL2_2 may extend in the first direction DR1. For example, the second-first transmission line VDTL2_1 may be disposed in the non-display area NDA on the first side of the display panel PNL2, and the second-second transmission line VDTL2_2 may be disposed in the non-display area NDA on the second side of the display panel PNL2. According to an embodiment, the second-first and second-second transmission lines VDTL2_1 and VDTL2_2 may be electrically connected to each other. For example, the second power transmission line VDTL2 including the second-first and second-second transmission lines VDTL2_1 and VDTL2_2 may extend continuously, and surround the display area DA in a plan view. For example, the second power transmission line VDTL2 may be arranged between the first power transmission line VDTL1 and the display area DA in a plan view.

According to an embodiment, the (m−1)^{th} power transmission line VDTLm−1 may include an (m−1)^{th}-first transmission line VDTLm−1_1 and an (m−1)^{th}-second transmission line VDTLm−1_2, which are spaced apart from each other, and each of the (m−1)^{th}-first transmission line VDTLm−1_1 and the (m−1)^{th}-second transmission line VDTLm−1_2 may extend in the first direction DR1. For example, the (m−1)^{th}-first transmission line VDTLm−1_1 may be disposed in the non-display area NDA on the first side of the display panel PNL2, and the (m−1)^{th}-second transmission line VDTLm−1_2 may be disposed in the non-display area NDA on the second side of the display panel PNL2. According to an embodiment, the (m−1)^{th}-first and (m−1)^{th}-second transmission lines VDTLm−1_1 and VDTLm−1_2 may be electrically connected to each other. For example, the (m−1)^{th} power transmission line VDTLm−1 including the (m−1)^{th}-first and (m−1)^{th}-second transmission lines VDTLm−1_1 and VDTLm−1_2 may extend continuously, and surround the display area DA in a plan view. For example, the (m−1)^{th} power transmission line VDTLm−1 may be arranged between the (m−2)^{th} power transmission line and the display area DA in a plan view.

According to an embodiment, the m^{th} power transmission line VDTLm may include an m^{th}-first transmission line VDTLm_1 and an m^{th}-second transmission line VDTLm_2, which are spaced apart from each other, and each of the m^{th}-first transmission line VDTLm_1 and the m^{th}-second transmission line VDTLm_2 may extend in the first direction DR1. For example, the m^{th}-first transmission line VDTLm_1 may be disposed in the non-display area NDA on the first side of the display panel PNL2, and the m^{th}-second transmission line VDTLm_2 may be disposed in the non-display area NDA on the second side of the display panel PNL2. According to an embodiment, the m^{th}-first and m^{th}-second transmission lines VDTLm_1 and VDTLm_2 may be electrically connected to each other. For example, the m^{th} power transmission line VDTLm including the m^{th}-first and m^{th}-second transmission lines VDTLm_1 and VDTLm_2 may extend continuously, and surround the display area DA in a plan view. For example, the m^{th} power transmission line VDTLm may be arranged between the (m−1)^{th} power transmission line VDTLm−1 and the display area DA in a plan view.

According to an embodiment, the (m+1)^{th} power transmission line VDTLm+1 may include an (m+1)^{th}-first transmission line VDTLm+1_1 and an (m+1)^{th}-second transmission line VDTLm+1_2, which are spaced apart from each other, and each of the (m+1)^{th}-first transmission line VDTLm+1_1 and the (m+1)^{th}-second transmission line VDTLm+1_2 may extend in the first direction DR1. For example, the (m+1)^{th}-first transmission line VDTLm+1_1 may be disposed in the non-display area NDA on the first side of the display panel PNL2, and the (m+1)^{th}-second transmission line VDTLm+1_2 may be disposed in the non-display area NDA on the second side of the display panel PNL2. According to an embodiment, the (m+1)^{th}-first and (m+1)^{th}-second transmission lines VDTLm+1_1 and VDTLm+1_2 may be electrically connected to each other. For example, the (m+1)^{th} power transmission line VDTLm+1 including the (m+1)^{th}-first and (m+1)^{th}-second transmission lines VDTLm+1_1 and VDTLm+1_2 may extend continuously, and surround the display area DA in a plan view. For example, the (m+1)^{th} power transmission line VDTLm+1 may be arranged between the m^{th} power transmission line VDTLm and the display area DA in a plan view.

According to an embodiment, the (m+2)^{th} power transmission line VDTLm+2 may include an (m+2)^{th}-first transmission line VDTLm+2_1 and an (m+2)^{th}-second transmission line VDTLm+2_2, which are spaced apart from each other, and each of the (m+2)^{th}-first transmission line VDTLm+2_1 and the (m+2)^{th}-second transmission line VDTLm+2_2 may extend in the first direction DR1. For example, the (m+2)^{th}-first transmission line VDTLm+2_1 may be disposed in the non-display area NDA on the first side of the display panel PNL2, and the (m+2)^{th}-second transmission line VDTLm+2_2 may be disposed in the non-display area NDA on the second side of the display panel PNL2. According to an embodiment, the (m+2)^{th}-first and (m+2)^{th}-second transmission lines VDTLm+2_1 and VDTLm+2_2 may be electrically connected to each other. For example, the (m+2)^{th} power transmission line VDTLm+2 including the (m+2)^{th}-first and (m+2)^{th}-second transmission lines VDTLm+2_1 and VDTLm+2_2 may extend continuously, and surround the display area DA in a plan view. For example, the (m+2)^{th} power transmission line VDTLm+2 may be arranged between the (m+1)^{th} power transmission line VDTLm+1 and the display area DA in a plan view.

According to an embodiment, the (2m−1)^{th} power transmission line VDTL2m−1 may include a (2m−1)^{th}-first transmission line VDTL2m−1_1 and a (2m−1)^{th}-second transmission line VDTL2m−1_2, which are spaced apart from each other, and each of the (2m−1)^{th}-first transmission line VDTL2m−1_1 and the (2m−1)^{th}-second transmission line VDTL2m−1_2 may extend in the first direction DR1. For example, the (2m−1)th-first transmission line VDTL2m−1_1 may be disposed in the non-display area NDA on the first side of the display panel PNL2, and the (2m−1)^{th}-second transmission line VDTL2m−1_2 may be disposed in the non-display area NDA on the second side of the display panel PNL2. According to an embodiment, the (2m−1)^{th}-first and (2m−1)th-second transmission lines VDTL2m−1_1 and VDTL2m−1_2 may be electrically connected to each other. For example, the (2m−1)^{th} power transmission line VDTL2m−1 including the (2m−1)^{th}-first and (2m−1)^{th}-second transmission lines VDTL2m−1_1 and VDTL2m−1_2 may extend continuously, and surround the display area DA in a plan view. For example, the (2m−1)^{th} power transmission line VDTL2m−1 may be arranged between the (2m−2)^{th} power transmission line and the display area DA in a plan view.

According to an embodiment, the 2m^{th} power transmission line VDTL2m may include a 2m^{th}-first transmission line VDTL2m_1 and a 2m^{th}-second transmission line VDTL2m_2, which are spaced apart from each other, and each of the 2m^{th}-first transmission line VDTL2m_1 and the 2m^{th}-second transmission line VDTL2m_2 may extend in the first direction DR1. For example, the 2m^{th}-first transmission line VDTL2m_1 may be disposed in the non-display area NDA on the first side of the display panel PNL2, and the 2m^{th}-second transmission line VDTL2Lm_2 may be disposed in the non-display area NDA on the second side of the display panel PNL2. According to an embodiment, the 2m^{th}-first and 2m^{th}-second transmission lines VDTL2m_1 and VDTL2m_2 may be electrically connected to each other. For example, the 2m^{th} power transmission line VDTL2m including the 2m^{th}-first and 2m^{th}-second transmission lines VDTL2m_1 and VDTL2m_2 may extend continuously, and surround the display area DA in a plan view. For example, the 2m^{th} power transmission line VDTL2m may be arranged between the (2m−1)^{th} power transmission line VDTL2m−1 and the display area DA in a plan view.

The display panel PNL2 may include first to 2m^{th} power pad connection lines VPCL1, . . . , and VPCL2m arranged in the non-display area NDA. The first to 2m^{th} power transmission lines VDTL1, . . . , and VDTL2m may be electrically connected to the first to 2m^{th} power pads VDP1, . . . , and VDP2m through the first to 2m^{th} power pad connection lines VPCL1, . . . , and VPCL2m, respectively. For example, each of the first to 2m^{th} power pad connection lines VPCL1, . . . , and VPCL2m may extend in the second direction DR2.

For example, the first power transmission line VDTL1 may be electrically connected to the first power pad VDP1 through the first power pad connection line VPCL1. The second power transmission line VDTL2 may be electrically connected to the second power pad VDP2 through the second power pad connection line VPCL2. The (m−1)^{th} power transmission line VDTLm−1 may be electrically connected to the (m−1)^{th} power pad VDPm−1 through the (m−1)^{th} power pad connection line VPCLm−1. The m^{th} power transmission line VDTLm may be electrically connected to the m^{th} power pad VDPm through the m^{th} power pad connection line VPCLm. The (m+1)^{th} power transmission line VDTLm+1 may be electrically connected to the (m+1)^{th} power pad VDPm+1 through the (m+1)^{th} power pad connection line VPCLm+1. The (m+2)^{th} power transmission line VDTLm+2 may be electrically connected to the (m+2)^{th} power pad VDPm+2 through the (m+2)^{th} power pad connection line VPCLm+2. The (2m−1)^{th} power transmission line VDTL2m−1 may be electrically connected to the (2m−1)^{th} power pad VDP2m−1 through the (2m−1)^{th} power pad connection line VPCL2m−1. The 2m^{th} power transmission line VDTL2m may be electrically connected to the 2m^{th} power pad VDP2m through the 2m^{th} power pad connection line VPCL2m. Accordingly, the first to 2m^{th} power transmission lines VDTL1, . . . , and VDTL2m may receive the first to 2m^{th} power voltages VD1, . . . , and VD2m, respectively.

The display panel PNL2 may include first to 2m^{th} connection lines VDCL1, . . . , and VDCL2m. The first to 2m^{th} power transmission lines VDTL1, . . . , and VDTL2m may be electrically connected to the first to 2m^{th} lines ML1, . . . , and ML2m through the first to 2m^{th} connection lines VDCL1, . . . , and VDCL2m, respectively. Each of the first to 2m^{th} connection lines VDCL1, . . . , and VDCL2m may extend in a vertical direction (e.g., the second direction DR2 or the pixel column direction).

Each of the first to m^{th} connection lines VDCL1, . . . , and VDCLm may overlap the first to m^{th} display areas DA1, . . . , and DAm (i.e., the first to m^{th} lines ML1, . . . , and MLm) in a plan view, and each of the (m+1)^{th} to 2m^{th} connection lines VDCLm+1, . . . , and VDCL2m may overlap the (m+1)^{th} to 2m^{th} display areas DAm+1, . . . , and DA2m (i.e., the (m+1)^{th} to 2m^{th} lines MLm+1, . . . , and ML2m) in a plan view. The first to 2m^{th} connection lines VDCL1, . . . , and VDCL2m may be connected to each of the transmission lines, which are included in each of the first to 2m^{th} power transmission lines VDTL1, . . . , and VDTL2m. In other words, each of the first to 2m^{th} connection lines VDCL1, . . . , and VDCL2m may extend from the non-display area NDA on the first side, traverse the display area DA, and extend to the non-display area NDA on the second side.

According to an embodiment, the first connection line VDCL1 may extend in the second direction DR2, and may be electrically connected to each of the first-first and first-second transmission lines VDTL1_1 and VDTL1_2. The first connection line VDCL1 may electrically connect the first power transmission line VDTL1 disposed in the non-display area NDA to the first line ML1 disposed in the first display area DA1. The first connection line VDCL1 may be electrically connected to each of the first-first and first-second transmission lines VDTL1_1 and VDTL1_2 through a contact hole, and electrically insulated from other power transmission lines. The first connection line VDCL1 may be electrically connected to the first line ML1 of the first display area DA1 through a contact hole, and electrically insulated from other lines.

Accordingly, the first power voltage VD1 may be transmitted to the pixels, which are arranged in the first display area DA1 and connected to the first line ML1, through the first power pad VDP1, the first power pad connection line VPCL1, the first power transmission line VDTL1 (i.e., the first-first and first-second transmission lines VDTL1_1 and VDTL1_2), and the first connection line VDCL1.

According to an embodiment, the second connection line VDCL2 may extend in the second direction DR2, and may be electrically connected to each of the second-first and second-second transmission lines VDTL2_1 and VDTL2_2. The second connection line VDCL2 may electrically connect the second power transmission line VDTL2 disposed in the non-display area NDA to the second line ML2 disposed in the second display area DA2. The second connection line VDCL2 may be electrically connected to each of the second-first and second-second transmission lines VDTL2_1 and VDTL2_2 through a contact hole, and electrically insulated from other power transmission lines. The second connection line VDCL2 may be electrically connected to the second line ML2 of the second display area DA2 through a contact hole, and electrically insulated from other lines.

Accordingly, the second power voltage VD2 may be transmitted to the pixels, which are arranged in the second display area DA2 and connected to the second line ML2, through the second power pad VDP2, the second power pad connection line VPCL2, the second power transmission line VDTL2 (i.e., the second-first and second-second transmission lines VDTL2_1 and VDTL2_2), and the second connection line VDCL2.

According to an embodiment, the (m−1)^{th} connection line VDCLm−1 may extend in the second direction DR2, and may be electrically connected to each of the (m−1)^{th}-first and (m−1)^{th}-second transmission lines VDTLm−1_1 and VDTLm−1_2. The (m−1)^{th} connection line VDCLm−1 may electrically connect the (m−1)^{th} power transmission line VDTLm−1 disposed in the non-display area NDA to the (m−1)^{th} line MLm−1 disposed in the (m−1)^{th} display area DAm−1. The (m−1)^{th} connection line VDCLm−1 may be electrically connected to each of the (m−1)^{th}-first and (m−1)^{th}-second transmission lines VDTLm−1_1 and VDTLm−1_2 through a contact hole, and electrically insulated from other power transmission lines. The (m−1)^{th} connection line VDCLm−1 may be electrically connected to the (m−1)^{th} line MLm−1 of the (m−1)^{th} display area DAm−1 through a contact hole, and electrically insulated from other lines.

Accordingly, the (m−1)^{th} power voltage VDm−1 may be transmitted to the pixels, which are arranged in the (m−1)^{th} display area DAm−1 and connected to the (m−1)^{th} line MLm−1, through the (m−1)^{th} power pad VDPm−1, the (m−1)^{th} power pad connection line VPCLm−1, the (m−1)^{th} power transmission line VDTLm−1 (i.e., the (m−1)^{th}-first and (m−1)^{th}-second transmission lines VDTLm−1_1 and VDTLm−1_2), and the (m−1)^{th} connection line VDCLm−1.

According to an embodiment, the m^{th} connection line VDCLm may extend in the second direction DR2, and may be electrically connected to each of the m^{th}-first and m^{th}-second transmission lines VDTLm_1 and VDTLm_2. The m^{th} connection line VDCLm may electrically connect the m^{th} power transmission line VDTLm disposed in the non-display area NDA to the m^{th} line MLm disposed in the m^{th} display area DAm. The m^{th} connection line VDCLm may be electrically connected to each of the m^{th}-first and m^{th}-second transmission lines VDTLm_1 and VDTLm_2 through a contact hole, and electrically insulated from other power transmission lines. The m^{th} connection line VDCLm may be electrically connected to the m^{th} line MLm of the m^{th} display area DAm through a contact hole, and electrically insulated from other lines.

Accordingly, the m^{th} power voltage VDm may be transmitted to the pixels, which are arranged in the m^{th} display area DAm and connected to the m^{th} line MLm, through the m^{th} power pad VDPm, the m^{th} power pad connection line VPCLm, the m^{th} power transmission line VDTLm (i.e., the m^{th}-first and m^{th}-second transmission lines VDTLm_1 and VDTLm_2), and the m^{th} connection line VDCLm.

According to an embodiment, the (m+1)^{th} connection line VDCLm+1 may extend in the second direction DR2, and may be electrically connected to each of the (m+1)^{th}-first and (m+1)^{th}-second transmission lines VDTLm+1_1 and VDTLm+1_2. The (m+1)^{th} connection line VDCLm+1 may electrically connect the (m+1)^{th} power transmission line VDTLm+1 disposed in the non-display area NDA to the (m+1)^{th} line MLm+1 disposed in the (m+1)^{th} display area DAm+1. The (m+1)^{th} connection line VDCLm+1 may be electrically connected to each of the (m+1)^{th}-first and (m+1)th-second transmission lines VDTLm+1_1 and VDTLm+1_2 through a contact hole, and electrically insulated from other power transmission lines. The (m+1)^{th} connection line VDCLm+1 may be electrically connected to the (m+1)^{th} line MLm+1 of the (m+1)^{th} display area DAm+1 through a contact hole, and electrically insulated from other lines.

Accordingly, the (m+1)^{th} power voltage VDm+1 may be transmitted to the pixels, which are arranged in the (m+1)^{th} display area DAm+1 and connected to the (m+1)^{th} line MLm+1, through the (m+1)^{th} power pad VDPm+1, the (m+1)^{th} power pad connection line VPCLm+1, the (m+1)^{th} power transmission line VDTLm+1 (i.e., the (m+1)^{th}-first and (m+1)^{th}-second transmission lines VDTLm+1_1 and VDTLm+1_2), and the (m+1)^{th} connection line VDCLm+1.

According to an embodiment, the (m+2)^{th} connection line VDCLm+2 may extend in the second direction DR2, and may be electrically connected to each of the (m+2)^{th}-first and (m+2)^{th}-second transmission lines VDTLm+2_1 and VDTLm+2_2. The (m+2)^{th} connection line VDCLm+2 may electrically connect the (m+2)^{th} power transmission line VDTLm+2 disposed in the non-display area NDA to the (m+2)^{th} line MLm+2 disposed in the (m+2)^{th} display area DAm+2. The (m+2)^{th} connection line VDCLm+2 may be electrically connected to each of the (m+2)^{th}-first and (m+2)th-second transmission lines VDTLm+2_1 and VDTLm+2_2 through a contact hole, and electrically insulated from other power transmission lines. The (m+2)^{th} connection line VDCLm+2 may be electrically connected to the (m+2)^{th} line MLm+2 of the (m+2)^{th} display area DAm+2 through a contact hole, and electrically insulated from other lines.

Accordingly, the (m+2)^{th} power voltage VDm+2 may be transmitted to the pixels, which are arranged in the (m+2)^{th} display area DAm+2 and connected to the (m+2)^{th} line MLm+2, through the (m+2)^{th} power pad VDPm+2, the (m+2)^{th} power pad connection line VPCLm+2, the (m+2)^{th} power transmission line VDTLm+2 (i.e., the (m+2)^{th}-first and (m+2)^{th}-second transmission lines VDTLm+2_1 and VDTLm+2_2), and the (m+2)^{th} connection line VDCLm+2.

According to an embodiment, the (2m−1)^{th} connection line VDCL2m−1 may extend in the second direction DR2, and may be electrically connected to each of the (2m−1)^{th}-first and (2m−1)^{th}-second transmission lines VDTL2m−1_1 and VDTL2m−1_2. The (2m−1)^{th} connection line VDCL2m−1 may electrically connect the (2m−1)^{th} power transmission line VDTL2m-1 disposed in the non-display area NDA to the (2m−1)^{th} line ML2m−1 disposed in the (2m−1)^{th} display area DA2m−1. The (2m−1)^{th} connection line VDCL2m−1 may be electrically connected to each of the (2m−1)^{th}-first and (2m−1)th-second transmission lines VDTL2m−1_1 and VDTL2m−1_2 through a contact hole, and electrically insulated from other power transmission lines. The (2m−1)^{th} connection line VDCL2m−1 may be electrically connected to the (2m−1)^{th} line ML2m−1 of the (2m−1)^{th} display area DA2m-1 through a contact hole, and electrically insulated from other lines.

Accordingly, the (2m−1)^{th} power voltage VD2m−1 may be transmitted to the pixels, which are arranged in the (2m−1)^{th} display area DA2m−1 and connected to the (2m−1)^{th} line ML2m−1, through the (2m−1)^{th} power pad VDP2m−1, the (2m−1)^{th} power pad connection line VPCL2m−1, the (2m−1)^{th} power transmission line VDTL2m−1 (i.e., the (2m−1)^{th}-first and (2m−1)^{th}-second transmission lines VDTL2m−1_1 and VDTL2m−1_2), and the (2m−1)^{th} connection line VDCL2m−1.

According to an embodiment, the 2m^{th} connection line VDCL2m may extend in the second direction DR2, and may be electrically connected to each of the 2m^{th}-first and 2m^{th}-second transmission lines VDTL2m_1 and VDTL2m_2. The 2m^{th} connection line VDCL2m may electrically connect the 2m^{th} power transmission line VDTL2m disposed in the non-display area NDA to the 2m^{th} line ML2m disposed in the 2m^{th} display area DA2m. The 2m^{th} connection line VDCL2m may be electrically connected to each of the 2m^{th}-first and 2m^{th}-second transmission lines VDTL2m_1 and VDTL2m_2 through a contact hole, and electrically insulated from other power transmission lines. The 2m^{th} connection line VDCL2m may be electrically connected to the 2m^{th} line ML2m of the 2m^{th} display area DA2m through a contact hole, and electrically insulated from other lines.

Accordingly, the 2m^{th} power voltage VD2m may be transmitted to the pixels, which are arranged in the 2m^{th} display area DA2m and connected to the 2m^{th} line ML2m, through the 2m^{th} power pad VDP2m, the 2m^{th} power pad connection line VPCL2m, the 2m^{th} power transmission line VDTL2m (i.e., the 2m^{th}-first and 2m^{th}-second transmission lines VDTL2m_1 and VDTL2m_2), and the 2m^{th} connection line VDCL2m.

The display area DA has been shown in FIG. 6 as being partitioned into two areas in the pixel row direction (e.g., the first direction DR1), and partitioned into m areas in the pixel column direction (e.g., the second direction DR2). However, since the above configuration is provided for illustrative purposes, the disclosure is not limited thereto, and the display area DA may be partitioned into at least two areas in the pixel row direction and/or the pixel column direction.

According to the display device DD2 of an embodiment of the disclosure, a plurality of power voltages may be provided to a plurality of display areas, respectively, and connection lines configured to provide the power voltages may be connected to power transmission lines, respectively, on both sides (e.g., at upper and lower ends in a plan view) of the display panel PNL2. Accordingly, a voltage drop difference between both sides (e.g., upper and lower ends in a plan view) of the display area DA of the display panel PNL2 may be minimized, and display quality of the display device DD2 may be effectively improved.

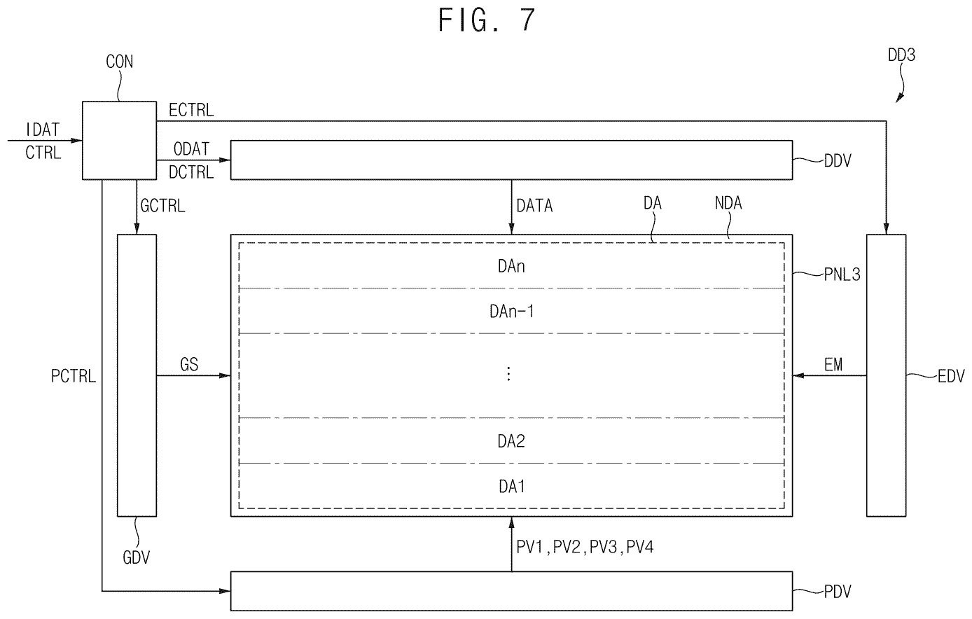

FIG. 7 is a block diagram showing a display device according to an embodiment of the disclosure.

Hereinafter, redundant descriptions corresponding to the display device DD1 described with reference to FIGS. 1 to 4 will be omitted or simplified.

Referring to FIG. 7, a display device DD3 may include a display panel PNL3, and a driver configured to drive the display panel PNL3. The display panel PNL3 may include a display area DA in which a plurality of pixels are arranged, and a non-display area NDA in which the driver is disposed. For example, the driver may provide signals and/or voltages to the pixels, and may include a gate driver GDV, an emission driver EDV, a data driver DDV, a power supplier PDV, and a controller CON.

The display area DA may include a plurality of display areas. For example, the display area DA may be partitioned into n display areas (where n is a natural number that is greater than or equal to 2), which are first to n^{th} display areas DA1, . . . , and DAn. The first to n^{th} display areas DA1, . . . , and DAn may be arranged in one direction, but the disclosure is not limited thereto. The pixels may be arranged in each of the first to n^{th} display areas DA1, . . . , and DAn.

The display panel PNL3 may be driven at a variable driving frequency. According to an embodiment, the display panel PNL3 driven at the variable driving frequency may be driven by a cycle scheme. The cycle scheme may mean performing a light emission operation in predetermined cycles. A stain caused by a luminance difference may be visually recognized depending on a frequency of the light emission operation in the display panel PNL3 driven by the cycle scheme. The stain may be referred to as mura.

For example, when the display panel PNL3 is driven at 240 Hz, and the light emission operation is driven at 480 Hz, the display panel PNL3 may operate in two cycles. In this case, the mura may be visually recognized in two pixel rows corresponding to the two cycles at a specific time point in the display panel PNL3. For example, when the display panel PNL3 is driven at 120 Hz, and the light emission operation is driven at 480 Hz, the display panel PNL3 may operate in four cycles. Here, the number of cycle operations may mean the number of light emission operations per image frame. This number is calculated by dividing the frequency at which the light emission operation is driven by the frequency at which the display panel is driven. In this case, the mura may be visually recognized in four pixel rows corresponding to four cycles at a specific time point in the display panel PNL3.

According to an embodiment, the display area DA may be partitioned into areas such that the number of the areas is greater than or equal to the number of cycle operations of the display panel PNL3. When the display panel PNL3 operates in p cycles (where p is a natural number that is greater than or equal to 2), the display area DA may be divided into at least p display areas. In other words, when the display panel PNL3 operates in p cycles, and the display area DA includes n display areas, n may be greater than or equal to p.

The power supplier PDV may generate power voltages based on a power driving control signal PCTRL. The power supplier PDV may generate a first power voltage PV1, a second power voltage PV2, a third power voltage PV3, and a fourth power voltage PV4. The first to fourth power voltages PV1, PV2, PV3, and PV4 may be provided to each of the pixels arranged in the display area DA. Each of the first to fourth power voltages PV1, PV2, PV3, and PV4 may be one of the power voltages received by a pixel circuit of each of the pixels. For example, the first power voltage PV1 may be the high power voltage VDD of FIG. 3, the second power voltage PV2 may be the reference voltage VREF of FIG. 3, the third power voltage PV3 may be the initialization voltage VINT of FIG. 3, and the fourth power voltage PV4 may be the low power voltage VSS of FIG. 3, but the disclosure is not limited thereto. For example, some of the first to fourth power voltages PV1, PV2, PV3, and PV4 may be omitted. In other words, each of the first to fourth power voltages PV1, PV2, PV3, and PV4 may be at least one of the power voltages received by the pixel circuit of each of the pixels.

FIG. 8 is a plan view showing a display panel included in the display device of FIG. 7.

Referring to FIGS. 7 and 8, the display panel PNL3 may include the display area DA including the first to n^{th} display areas DA1, . . . , and DAn, and the non-display area NDA.

The display panel PNL3 may include first to n^{th} lines ML1, . . . , and MLn arranged in the first to n^{th} display areas DA1, . . . , and DAn, respectively. Each of the first to n^{th} lines ML1, . . . , and MLn may extend in a first direction DR1. Each of the first to n^{th} lines ML1, . . . , and MLn may include a plurality of lines extending in the first direction DR1. The first to n^{th} lines ML1, . . . , and MLn may be spaced apart from each other, and electrically insulated from each other.

Each of the first to n^{th} lines ML1, . . . , and MLn may receive the first to fourth power voltages PV1, PV2, PV3, and PV4 from the power supplier PDV, and may be electrically connected to the pixels arranged in a corresponding display area so as to transmit the first to fourth power voltages PV1, PV2, PV3, and PV4.

For example, the first line ML1 may provide the first to fourth power voltages PV1, PV2, PV3, and PV4 to the pixels arranged in the first display area DA1. The second line ML2 may provide the first to fourth power voltages PV1, PV2, PV3, and PV4 to the pixels arranged in the second display area DA2. The (n−1)^{th} line MLn−1 may provide the first to fourth power voltages PV1, PV2, PV3, and PV4 to the pixels arranged in the (n−1)^{th} display area DAn−1. The n^{th} line MLn may provide the first to fourth power voltages PV1, PV2, PV3, and PV4 to the pixels arranged in the n^{th} display area DAn.

The display panel PNL3 may include first to fourth power pads PVP1, PVP2, PVP3, and PVP4 arranged in the non-display area NDA. The first to fourth power pads PVP1, PVP2, PVP3, and PVP4 may receive the first to fourth power voltages PV1, PV2, PV3, and PV4 from the power supplier PDV, respectively. The first to fourth power pads PVP1, PVP2, PVP3, and PVP4 may be arranged in the first direction DR1.

The display panel PNL3 may include first to fourth power transmission lines PVTL1, PVTL2, PVTL3, and PVTL4 arranged in the non-display area NDA. The first to fourth power transmission lines PVTL1, PVTL2, PVTL3, and PVTL4 may be spaced apart from each other, and electrically insulated from each other.

Each of the first to fourth power transmission lines PVTL1, PVTL2, PVTL3, and PVTL4 may include a plurality of transmission lines spaced apart from each other and extending in the first direction DR1. The transmission lines of each of the first to fourth power transmission lines PVTL1, PVTL2, PVTL3, and PVTL4 may be arranged on both sides (e.g., both sides in a second direction DR2) of the display panel PNL3, respectively. The transmission lines of each of the first to fourth power transmission lines PVTL1, PVTL2, PVTL3, and PVTL4 may be electrically connected to each other. For example, each of the first to fourth power transmission lines PVTL1, PVTL2, PVTL3, and PVTL4 may extend continuously, and surround the display area DA in a plan view.

According to an embodiment, the first power transmission line PVTL1 may include a first-first transmission line PVTL1_1 and a first-second transmission line PVTL1_2, which are spaced apart from each other, and each of the first-first transmission line PVTL1_1 and the first-second transmission line PVTL1_2 may extend in the first direction DR1. For example, the first-first transmission line PVTL1_1 may be disposed in the non-display area NDA on a first side of the display panel PNL3 (e.g., at a lower end of the display panel PNL3 in a plan view), and the first-second transmission line PVTL1_2 may be disposed in the non-display area NDA on a second side that is opposite to the first side of the display panel PNL3 (e.g., at an upper end of the display panel PNL3 in a plan view). According to an embodiment, the first-first and first-second transmission lines PVTL1_1 and PVTL1_2 may be electrically connected to each other. For example, the first power transmission line PVTL1 including the first-first and first-second transmission lines PVTL1_1 and PVTL1_2 may extend continuously, and surround the display area DA in a plan view.

According to an embodiment, the second power transmission line PVTL2 may include a second-first transmission line PVTL2_1 and a second-second transmission line PVTL2_2, which are spaced apart from each other, and each of the second-first transmission line PVTL2_1 and the second-second transmission line PVTL2_2 may extend in the first direction DR1. For example, the second-first transmission line PVTL2_1 may be disposed in the non-display area NDA on the first side of the display panel PNL3, and the second-second transmission line PVTL2_2 may be disposed in the non-display area NDA on the second side of the display panel PNL3. According to an embodiment, the second-first and second-second transmission lines PVTL2_1 and PVTL2_2 may be electrically connected to each other. For example, the second power transmission line PVTL2 including the second-first and second-second transmission lines PVTL2_1 and PVTL2_2 may extend continuously, and surround the display area DA in a plan view. For example, the second power transmission line PVTL2 may be arranged between the first power transmission line PVTL1 and the display area DA in a plan view.

According to an embodiment, the third power transmission line PVTL3 may include a third-first transmission line PVTL3_1 and a third-second transmission line PVTL3_2, which are spaced apart from each other, and each of the third-first transmission line PVTL3_1 and the third-second transmission line PVTL3_2 may extend in the first direction DR1. For example, the third-first transmission line PVTL3_1 may be disposed in the non-display area NDA on the first side of the display panel PNL3, and the third-second transmission line PVTL3_2 may be disposed in the non-display area NDA on the second side of the display panel PNL3. According to an embodiment, the third-first and third-second transmission lines PVTL3_1 and PVTL3_2 may be electrically connected to each other. For example, the third power transmission line PVTL3 including the third-first and third-second transmission lines PVTL3_1 and PVTL3_2 may extend continuously, and surround the display area DA in a plan view. For example, the third power transmission line PVTL3 may be arranged between the second power transmission line PVTL2 and the display area DA in a plan view.

According to an embodiment, the fourth power transmission line PVTL4 may include a fourth-first transmission line PVTL4_1 and a fourth-second transmission line PVTL4_2, which are spaced apart from each other, and each of the fourth-first transmission line PVTL4_1 and the fourth-second transmission line PVTL4_2 may extend in the first direction DR1. For example, the fourth-first transmission line PVTL4_1 may be disposed in the non-display area NDA on the first side of the display panel PNL3, and the fourth-second transmission line PVTL4_2 may be disposed in the non-display area NDA on the second side of the display panel PNL3. According to an embodiment, the fourth-first and fourth-second transmission lines PVTL4_1 and PVTL4_2 may be electrically connected to each other. For example, the fourth power transmission line PVTL4 including the fourth-first and fourth-second transmission lines PVTL4_1 and PVTL4_2 may extend continuously, and surround the display area DA in a plan view. For example, the fourth power transmission line PVTL4 may be arranged between the third power transmission line PVTL3 and the display area DA in a plan view.

The display panel PNL3 may include first to fourth power pad connection lines PPCL1, PPCL2, PPCL3, and PPCL4 arranged in the non-display area NDA. The first to fourth power transmission lines PVTL1, PVTL2, PVTL3, and PVTL4 may be electrically connected to the first to fourth power pads PVP1, PVP2, PVP3, and PVP4 through the first to fourth power pad connection lines PPCL1, PPCL2, PPCL3, and PPCL4, respectively. For example, each of the first to fourth power pad connection lines PPCL1, PPCL2, PPCL3, and PPCL4 may extend in the second direction DR2.

For example, the first power transmission line PVTL1 may be electrically connected to the first power pad PVP1 through the first power pad connection line PPCL1. The second power transmission line PVTL2 may be electrically connected to the second power pad PVP2 through the second power pad connection line PPCL2. The third power transmission line PVTL3 may be electrically connected to the third power pad PVP3 through the third power pad connection line PPCL3. The fourth power transmission line PVTL4 may be electrically connected to the fourth power pad PVP4 through the fourth power pad connection line PPCL4.

The display panel PNL3 may include first-first to first-n^{th} power connection lines PVCL1_1, . . . , and PVCL1_n, second-first to second-n^{th} power connection lines PVCL2_1, . . . , and PVCL2_n, third-first to third-n^{th} power connection lines PVCL3_1, . . . , and PVCL3_n, and fourth-first to fourth-n^{th} power connection lines PVCL4_1, . . . , and PVCL4_n. The first power transmission line PVTL1 may be electrically connected to the first to n^{th} lines ML1, . . . , and MLn through the first-first to first-n^{th} power connection lines PVCL1_1, . . . , and PVCL1_n, respectively. The second power transmission line PVTL2 may be electrically connected to the first to n^{th} lines ML1, . . . , and MLn through the second-first to second-n^{th} power connection lines PVCL2_1, . . . , and PVCL2_n, respectively. The third power transmission line PVTL3 may be electrically connected to the first to n^{th} lines ML1, . . . , and MLn through the third-first to third-n^{th} power connection lines PVCL3_1, . . . , and PVCL3_n, respectively. The fourth power transmission line PVTL4 may be electrically connected to the first to n^{th} lines ML1, . . . , and MLn through the fourth-first to fourth-n^{th} power connection lines PVCL4_1, . . . , and PVCL4_n, respectively.

Each of the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_nmay extend in the second direction DR2.

Each of the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_nmay overlap the first to n^{th} display areas DA1, . . . , and DAn (i.e., the first to n^{th} lines ML1, . . . , and MLn) in a plan view.

Each of the first-first to first-n^{th} power connection lines PVCL1_1, . . . , and PVCL1_nmay be electrically connected to each of the first-first and first-second transmission lines PVTL1_1 and PVTL1_2 included in the first power transmission line PVTL1. Each of the second-first to second-n^{th} power connection lines PVCL2_1, . . . , and PVCL2_nmay be electrically connected to each of the second-first and second-second transmission lines PVTL2_1 and PVTL2_2 included in the second power transmission line PVTL2. Each of the third-first to third-n^{th} power connection lines PVCL3_1, . . . , and PVCL3_nmay be electrically connected to each of the third-first and third-second transmission lines PVTL3_1 and PVTL3_2 included in the third power transmission line PVTL3. Each of the fourth-first to fourth-n^{th} power connection lines PVCL4_1, . . . , and PVCL4_nmay be electrically connected to each of the fourth-first and fourth-second transmission lines PVTL4_1 and PVTL4_2 included in the fourth power transmission line PVTL4.

In other words, each of the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_nmay extend from the non-display area NDA on the first side, traverse the display area DA, and extend to the non-display area NDA on the second side.

According to an embodiment, the first-first to first-n^{th} power connection lines PVCL1_1, . . . , and PVCL1_nmay electrically connect the first power transmission line PVTL1 disposed in the non-display area NDA to the first to n^{th} lines ML1, . . . , and MLn arranged in the first to n^{th} display areas DA1, . . . , and DAn, respectively.

Each of the first-first to first-n^{th} power connection lines PVCL1_1, . . . , and PVCL1_nmay be electrically connected to each of the first-first and first-second transmission lines PVTL1_1 and PVTL1_2 through a contact hole, and electrically insulated from other power transmission lines.

The first-first power connection line PVCL1_1 may be electrically connected to the first line ML1 of the first display area DA1 through a contact hole, and electrically insulated from other lines. The first-second power connection line PVCL1_2 may be electrically connected to the second line ML2 of the second display area DA2 through a contact hole, and electrically insulated from other lines. The first-(n−1)^{th} power connection line PVCL1_n−1 may be electrically connected to the (n−1)^{th} line MLn−1 of the (n−1)^{th} display area DAn−1 through a contact hole, and electrically insulated from other lines. The first-n^{th} power connection line PVCL1_n may be electrically connected to the n^{th} line MLn of the n^{th} display area DAn through a contact hole, and electrically insulated from other lines.

Accordingly, the first power voltage PV1 may be transmitted to each of the pixels, which are arranged in the first to n^{th} display areas DA1, . . . , and DAn and connected to the first to n^{th} lines ML1, . . . , and MLn, through the first power pad PVP1, the first power pad connection line PPCL1, the first power transmission line PVTL1 (i.e., the first-first and first-second transmission lines PVTL1_1 and PVTL1_2), and the first-first to first-n^{th} power connection lines PVCL1_1, . . . , and PVCL1_n.

According to an embodiment, the second-first to second-n^{th} power connection lines PVCL2_1, . . . , and PVCL2_n may electrically connect the second power transmission line PVTL2 disposed in the non-display area NDA to the first to n^{th} lines ML1, . . . , and MLn arranged in the first to n^{th} display areas DA1, . . . , and DAn, respectively.

Each of the second-first to second-n^{th} power connection lines PVCL2_1, . . . , and PVCL2_n may be electrically connected to each of the second-first and second-second transmission lines PVTL2_1 and PVTL2_2 through a contact hole, and electrically insulated from other power transmission lines.

The second-first power connection line PVCL2_1 may be electrically connected to the first line ML1 of the first display area DA1 through a contact hole, and electrically insulated from other lines. The second-second power connection line PVCL2_2 may be electrically connected to the second line ML2 of the second display area DA2 through a contact hole, and electrically insulated from other lines. The second-(n−1)^{th} power connection line PVCL2_n−1 may be electrically connected to the (n−1)^{th} line MLn−1 of the (n−1)^{th} display area DAn−1 through a contact hole, and electrically insulated from other lines. The second-n^{th} power connection line PVCL2_n may be electrically connected to the n^{th} line MLn of the n^{th} display area DAn through a contact hole, and electrically insulated from other lines.

Accordingly, the second power voltage PV2 may be transmitted to each of the pixels, which are arranged in the first to n^{th} display areas DA1, . . . , and DAn and connected to the first to n^{th} lines ML1, . . . , and MLn, through the second power pad PVP2, the second power pad connection line PPCL2, the second power transmission line PVTL2 (i.e., the second-first and second-second transmission lines PVTL2_1 and PVTL2_2), and the second-first to second-n^{th} power connection lines PVCL2_1, . . . , and PVCL2_n.

According to an embodiment, the third-first to third-n^{th} power connection lines PVCL3_1, . . . , and PVCL3_n may electrically connect the third power transmission line PVTL3 disposed in the non-display area NDA to the first to n^{th} lines ML1, . . . , and MLn arranged in the first to n^{th} display areas DA1, . . . , and DAn, respectively.

Each of the third-first to third-n^{th} power connection lines PVCL3_1, . . . , and PVCL3_n may be electrically connected to each of the third-first and third-second transmission lines PVTL3_1 and PVTL3_2 through a contact hole, and electrically insulated from other power transmission lines.

The third-first power connection line PVCL3_1 may be electrically connected to the first line ML1 of the first display area DA1 through a contact hole, and electrically insulated from other lines. The third-second power connection line PVCL3_2 may be electrically connected to the second line ML2 of the second display area DA2 through a contact hole, and electrically insulated from other lines. The third-(n−1)^{th} power connection line PVCL3_n−1 may be electrically connected to the (n−1)^{th} line MLn−1 of the (n−1)^{th} display area DAn−1 through a contact hole, and electrically insulated from other lines. The third-n^{th} power connection line PVCL3_n may be electrically connected to the n^{th} line MLn of the n^{th} display area DAn through a contact hole, and electrically insulated from other lines.

Accordingly, the third power voltage PV3 may be transmitted to each of the pixels, which are arranged in the first to n^{th} display areas DA1, . . . , and DAn and connected to the first to n^{th} lines ML1, . . . , and MLn, through the third power pad PVP3, the third power pad connection line PPCL3, the third power transmission line PVTL3 (i.e., the third-first and third-second transmission lines PVTL3_1 and PVTL3_2), and the third-first to third-n^{th} power connection lines PVCL3_1, . . . , and PVCL3_n.

According to an embodiment, the fourth-first to fourth-n^{th} power connection lines PVCL4_1, . . . , and PVCL4_n may electrically connect the fourth power transmission line PVTL4 disposed in the non-display area NDA to the first to n^{th} lines ML1, . . . , and MLn arranged in the first to n^{th} display areas DA1, . . . , and DAn, respectively.

Each of the fourth-first to fourth-n^{th} power connection lines PVCL4_1, . . . , and PVCL4_n may be electrically connected to each of the fourth-first and fourth-second transmission lines PVTL4_1 and PVTL4_2 through a contact hole, and electrically insulated from other power transmission lines.

The fourth-first power connection line PVCL4_1 may be electrically connected to the first line ML1 of the first display area DA1 through a contact hole, and electrically insulated from other lines. The fourth-second power connection line PVCL4_2 may be electrically connected to the second line ML2 of the second display area DA2 through a contact hole, and electrically insulated from other lines. The fourth-(n−1)^{th} power connection line PVCL4_n−1 may be electrically connected to the (n−1)^{th} line MLn−1 of the (n−1)^{th} display area DAn−1 through a contact hole, and electrically insulated from other lines. The fourth-n^{th} power connection line PVCL4_n may be electrically connected to the n^{th} line MLn of the n^{th} display area DAn through a contact hole, and electrically insulated from other lines.

Accordingly, the fourth power voltage PV4 may be transmitted to each of the pixels, which are arranged in the first to n^{th} display areas DA1, . . . , and DAn and connected to the first to n^{th} lines ML1, . . . , and MLn, through the fourth power pad PVP4, the fourth power pad connection line PPCL4, the fourth power transmission line PVTL4 (i.e., the fourth-first and fourth-second transmission lines PVTL4_1 and PVTL4_2), and the fourth-first to fourth-n^{th} power connection lines PVCL4_1, . . . , and PVCL4_n.

Although one power voltage has been shown in FIG. 8 as being transmitted to each of the first to n^{th} display areas DA1, . . . , and DAn by one power transmission line, the disclosure is not limited thereto. According to an embodiment, the display device DD3 may have a structure that is identical to the structure of each of the display devices DD1 and DD2 described with reference to FIGS. 1 to 6. For example, according to the display panel PNL3, one power voltage may be divided into first to n^{th} power voltages so as to be transmitted to the first to n^{th} display areas DA1, . . . , and DAn, respectively.

The display area DA has been shown in FIGS. 7 and 8 as being partitioned into n areas in a pixel column direction (e.g., the second direction DR2). However, since the above configuration is provided for illustrative purposes, the disclosure is not limited thereto, and the display area DA may be divided in a pixel row direction (e.g., the first direction DR1) and/or the pixel column direction.

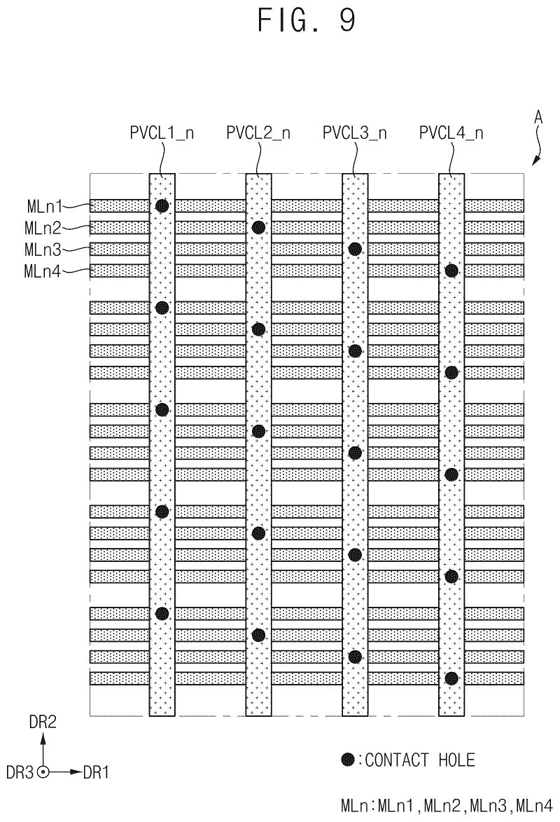

FIG. 9 is an enlarged plan view showing an area A of FIG. 8. Although an area in which the first-n^{th}, second-n^{th}, third-n^{th}, and fourth-n^{th} power connection lines PVCL1_n, PVCL2_n, PVCL3_n, and PVCL4_n and the n^{th} line MLn of the n^{th} display area DAn are electrically connected has been enlarged and shown in FIG. 9, the following descriptions may be applied to other areas in which the power connection lines and the line are electrically connected in a substantially identical or similar manner.

Referring to FIGS. 7, 8, and 9, each of the first to n^{th} lines ML1, . . . , and MLn may include a plurality of lines. For example, the n^{th} line MLn may include a first voltage line MLn1, a second voltage line MLn2, a third voltage line MLn3, and a fourth voltage line MLn4. Each of the first to fourth voltage lines MLn1, MLn2, MLn3, and MLn4 may extend in the first direction DR1, and may be arranged in a direction that is opposite to the second direction DR2. The first to fourth voltage lines MLn1, MLn2, MLn3, and MLn4 may be repeatedly arranged in the second direction DR2. The first to fourth voltage lines MLn1, MLn2, MLn3, and MLn4 may be spaced apart from each other, and electrically insulated from each other.

The first to fourth voltage lines MLn1, MLn2, MLn3, and MLn4 may be electrically connected to different power connection lines, and may receive different voltages.

For example, the first voltage line MLn1 may be electrically connected to the first-n^{th} power connection line PVCL1_n through a contact hole, and the first power voltage PV1 may be provided to the first voltage line MLn1. The second voltage line MLn2 may be electrically connected to the second-n^{th} power connection line PVCL2_n through a contact hole, and the second power voltage PV2 may be provided to the second voltage line MLn2. The third voltage line MLn3 may be electrically connected to the third-n^{th} power connection line PVCL3_n through a contact hole, and the third power voltage PV3 may be provided to the third voltage line MLn3. The fourth voltage line MLn4 may be electrically connected to the fourth-n^{th} power connection line PVCL4_n through a contact hole, and the fourth power voltage PV4 may be provided to the fourth voltage line MLn4.

According to the display device DD3 of an embodiment of the disclosure, the display area DA may be divided into a plurality of display areas such that the number of the display areas is greater than or equal to the number of cycle operations of the display panel PNL3, a plurality of power voltages may be provided to each of the display areas, and each of power connection lines configured to provide the power voltages, respectively, may be electrically connected to one of the display areas and electrically insulated from other display areas. Accordingly, upon the cycle operation of the display panel PNL3, an influence of a voltage drop caused by a light emission operation of one display area on other display areas may be minimized, mura that may be visually recognized upon the cycle operation of the display panel PNL3 may be minimized, and display quality of the display device DD3 may be effectively improved.

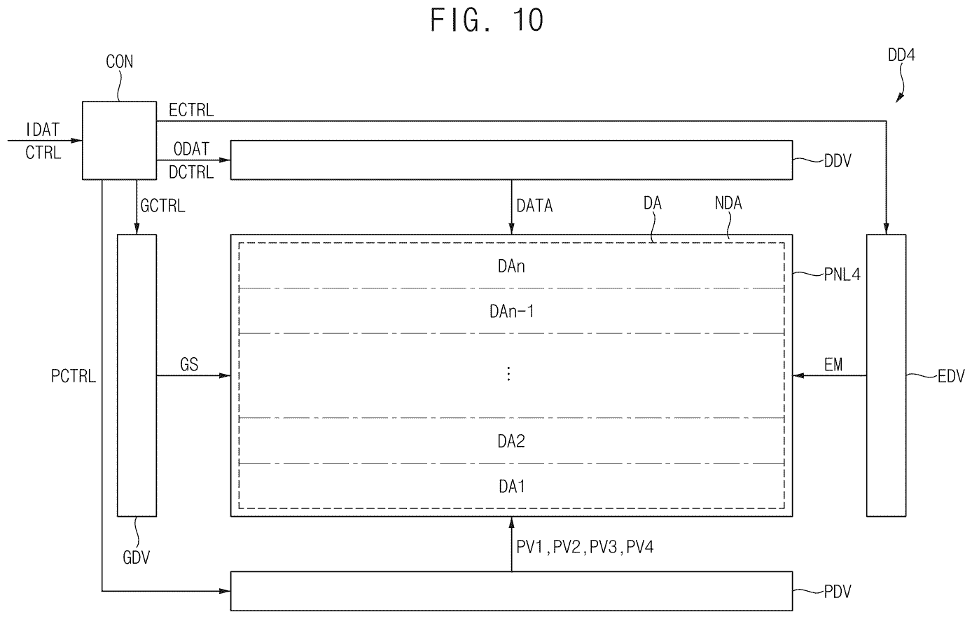

FIG. 10 is a block diagram showing a display device according to an embodiment of the disclosure.

Unlike the display device DD3 described with reference to FIGS. 7 to 9, in which the power transmission lines are arranged on both sides of the display panel PNL3, respectively, according to a display device DD4 that will be described with reference to FIG. 10, each of power transmission lines may be arranged on one side of the display panel PNL4.

Hereinafter, redundant descriptions corresponding to the display device DD1 described with reference to FIGS. 1 to 4 and the display device DD3 described with reference to FIGS. 7 to 9 will be omitted or simplified.

Referring to FIG. 10, the display device DD4 may include the display panel PNL4, and a driver configured to drive the display panel PNL4. The display panel PNL4 may include a display area DA in which a plurality of pixels are arranged, and a non-display area NDA in which the driver is disposed. For example, the driver may provide signals and/or voltages to the pixels, and may include a gate driver GDV, an emission driver EDV, a data driver DDV, a power supplier PDV, and a controller CON.

The display area DA may include a plurality of display areas. For example, the display area DA may be partitioned into n display areas (where n is a natural number that is greater than or equal to 2), which are first to n^{th} display areas DA1, . . . , and DAn. The first to n^{th} display areas DA1, . . . , and DAn may be arranged in one direction, but the disclosure is not limited thereto. The pixels may be arranged in each of the first to n^{th} display areas DA1, . . . , and DAn.

According to an embodiment, the display area DA may be partitioned into areas such that the number of the areas is greater than or equal to the number of cycle operations of the display panel PNL4. When the display panel PNL4 operates in p cycles (where p is a natural number that is greater than or equal to 2), the display area DA may be divided into at least p display areas. In other words, when the display panel PNL4 operates in p cycles, and the display area DA includes n display areas, n may be greater than or equal to p.

The power supplier PDV may generate a first power voltage PV1, a second power voltage PV2, a third power voltage PV3, and a fourth power voltage PV4 based on a power driving control signal PCTRL, and the first to fourth power voltages PV1, PV2, PV3, and PV4 may be provided to each of the pixels arranged in the display area DA. Each of the first to fourth power voltages PV1, PV2, PV3, and PV4 may be one of the voltages received by a pixel circuit of each of the pixels. For example, the first power voltage PV1 may be the high power voltage VDD of FIG. 3, the second power voltage PV2 may be the reference voltage VREF of FIG. 3, the third power voltage PV3 may be the initialization voltage VINT of FIG. 3, and the fourth power voltage PV4 may be the low power voltage VSS of FIG. 3, but the disclosure is not limited thereto. For example, some of the first to fourth power voltages PV1, PV2, PV3, and PV4 may be omitted. In other words, each of the first to fourth power voltages PV1, PV2, PV3, and PV4 may be at least one of the power voltages received by the pixel circuit of each of the pixels.

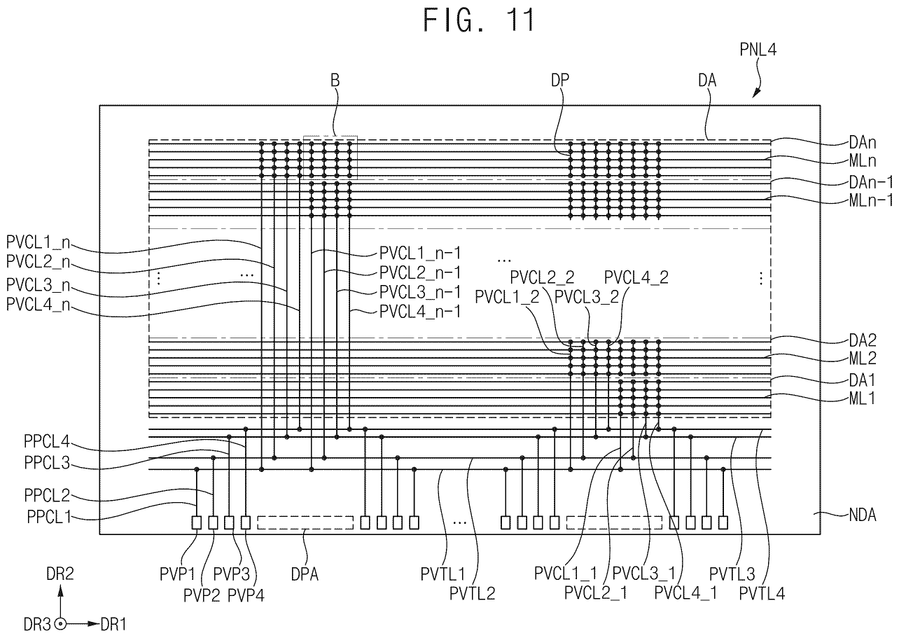

FIG. 11 is a plan view showing a display panel included in the display device of FIG. 10.

Referring to FIGS. 10 and 11, the display panel PNL4 may include the display area DA including the first to n^{th} display areas DA1, . . . , and DAn, and the non-display area NDA.

The display panel PNL4 may include first to n^{th} lines ML1, . . . , and MLn arranged in the first to n^{th} display areas DA1, . . . , and DAn, respectively. Each of the first to n^{th} lines ML1, . . . , and MLn may extend in a first direction DR1, and may include a plurality of lines extending in the first direction DR1. The first to n^{th} lines ML1, . . . , and MLn may be electrically insulated from each other.

Each of the first to n^{th} lines ML1, . . . , and MLn may receive the first to fourth power voltages PV1, PV2, PV3, and PV4 from the power supplier PDV, and may be electrically connected to the pixels arranged in a corresponding display area so as to transmit the first to fourth power voltages PV1, PV2, PV3, and PV4.

For example, the first line ML1 may provide the first to fourth power voltages PV1, PV2, PV3, and PV4 to the pixels arranged in the first display area DA1. The second line ML2 may provide the first to fourth power voltages PV1, PV2, PV3, and PV4 to the pixels arranged in the second display area DA2. The (n−1)^{th} line MLn−1 may provide the first to fourth power voltages PV1, PV2, PV3, and PV4 to the pixels arranged in the (n−1)^{th} display area DAn−1. The n^{th} line MLn may provide the first to fourth power voltages PV1, PV2, PV3, and PV4 to the pixels arranged in the n^{th} display area DAn.

The display panel PNL4 may include first to fourth power pads PVP1, PVP2, PVP3, and PVP4 arranged in the non-display area NDA. The first to fourth power pads PVP1, PVP2, PVP3, and PVP4 may receive the first to fourth power voltages PV1, PV2, PV3, and PV4 from the power supplier PDV, respectively. For example, the first to fourth power pads PVP1, PVP2, PVP3, and PVP4 may be arranged in the first direction DR1.

The display panel PNL4 may include first to fourth power transmission lines PVTL1, PVTL2, PVTL3, and PVTL4 arranged in the non-display area NDA. The first to fourth power transmission lines PVTL1, PVTL2, PVTL3, and PVTL4 may be spaced apart from each other, and electrically insulated from each other. Each of the first to fourth power transmission lines PVTL1, PVTL2, PVTL3, and PVTL4 may extend in the first direction DR1. The first to fourth power transmission lines PVTL1, PVTL2, PVTL3, and PVTL4 may be arranged on one side of the display panel PNL4 (e.g., at a lower end of the display panel PNL4 in a plan view). For example, the second power transmission line PVTL2 may be adjacent to the first power transmission line PVTL1 in the second direction DR2, the third power transmission line PVTL3 may be adjacent to the second power transmission line PVTL2 in the second direction DR2, and the fourth power transmission line PVTL4 may be adjacent to the third power transmission line PVTL3 in the second direction DR2.

The display panel PNL4 may include first to fourth power pad connection lines PPCL1, PPCL2, PPCL3, and PPCL4 arranged in the non-display area NDA. The first to fourth power transmission lines PVTL1, PVTL2, PVTL3, and PVTL4 may be electrically connected to the first to fourth power pads PVP1, PVP2, PVP3, and PVP4 through the first to fourth power pad connection lines PPCL1, PPCL2, PPCL3, and PPCL4, respectively. For example, each of the first to fourth power pad connection lines PPCL1, PPCL2, PPCL3, and PPCL4 may extend in the second direction DR2.

For example, the first power transmission line PVTL1 may be electrically connected to the first power pad PVP1 through the first power pad connection line PPCL1. The second power transmission line PVTL2 may be electrically connected to the second power pad PVP2 through the second power pad connection line PPCL2. The third power transmission line PVTL3 may be electrically connected to the third power pad PVP3 through the third power pad connection line PPCL3. The fourth power transmission line PVTL4 may be electrically connected to the fourth power pad PVP4 through the fourth power pad connection line PPCL4.

The display panel PNL4 may include first-first to first-n^{th} power connection lines PVCL1_1, . . . , and PVCL1_n, second-first to second-n^{th} power connection lines PVCL2_1, . . . , and PVCL2_n, third-first to third-n^{th} power connection lines PVCL3_1, . . . , and PVCL3_n, and fourth-first to fourth-n^{th} power connection lines PVCL4_1, . . . , and PVCL4_n. For example, each of the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_n may extend in the second direction DR2.

According to an embodiment, the first-first to first-n^{th} power connection lines PVCL1_1, . . . , and PVCL1_n may electrically connect the first power transmission line PVTL1 disposed in the non-display area NDA to the first to n^{th} lines ML1, . . . , and MLn arranged in the first to n^{th} display areas DA1, . . . , and DAn, respectively.

Each of the first-first to first-n^{th} power connection lines PVCL1_1, . . . , and PVCL1_n may be electrically connected to the first power transmission line PVTL1 through a contact hole, and electrically insulated from other power transmission lines.

The first-first power connection line PVCL1_1 may be electrically connected to the first line ML1 of the first display area DA1 through a contact hole, and electrically insulated from other lines. The first-second power connection line PVCL1_2 may be electrically connected to the second line ML2 of the second display area DA2 through a contact hole, and electrically insulated from other lines. The first-(n−1)^{th} power connection line PVCL1_n−1 may be electrically connected to the (n−1)^{th} line MLn−1 of the (n−1)^{th} display area DAn−1 through a contact hole, and electrically insulated from other lines. The first-n^{th} power connection line PVCL1_n may be electrically connected to the n^{th} line MLn of the n^{th} display area DAn through a contact hole, and electrically insulated from other lines.

Accordingly, the first power voltage PV1 may be transmitted to each of the pixels, which are arranged in the first to n^{th} display areas DA1, . . . , and DAn and connected to the first to n^{th} lines ML1, . . . , and MLn, through the first power pad PVP1, the first power pad connection line PPCL1, the first power transmission line PVTL1, and the first-first to first-n^{th} power connection lines PVCL1_1, . . . , and PVCL1_n.

According to an embodiment, the second-first to second-n^{th} power connection lines PVCL2_1, . . . , and PVCL2_n may electrically connect the second power transmission line PVTL2 disposed in the non-display area NDA to the first to n^{th} lines ML1, . . . , and MLn arranged in the first to n^{th} display areas DA1, . . . , and DAn, respectively.

Each of the second-first to second-n^{th} power connection lines PVCL2_1, . . . , and PVCL2_n may be electrically connected to the second power transmission line PVTL2 through a contact hole, and electrically insulated from other power transmission lines.

The second-first power connection line PVCL2_1 may be electrically connected to the first line ML1 of the first display area DA1 through a contact hole, and electrically insulated from other lines. The second-second power connection line PVCL2_2 may be electrically connected to the second line ML2 of the second display area DA2 through a contact hole, and electrically insulated from other lines. The second-(n−1)^{th} power connection line PVCL2_n−1 may be electrically connected to the (n−1)^{th} line MLn−1 of the (n−1)^{th} display area DAn−1 through a contact hole, and electrically insulated from other lines. The second-n^{th} power connection line PVCL2_n may be electrically connected to the n^{th} line MLn of the n^{th} display area DAn through a contact hole, and electrically insulated from other lines.

Accordingly, the second power voltage PV2 may be transmitted to each of the pixels, which are arranged in the first to n^{th} display areas DA1, . . . , and DAn and connected to the first to n^{th} lines ML1, . . . , and MLn, through the second power pad PVP2, the second power pad connection line PPCL2, the second power transmission line PVTL2, and the second-first to second-n^{th} power connection lines PVCL2_1, . . . , and PVCL2_n.

According to an embodiment, the third-first to third-n^{th} power connection lines PVCL3_1, . . . , and PVCL3_n may electrically connect the third power transmission line PVTL3 disposed in the non-display area NDA to the first to n^{th} lines ML1, . . . , and MLn arranged in the first to n^{th} display areas DA1, . . . , and DAn, respectively.

Each of the third-first to third-n^{th} power connection lines PVCL3_1, . . . , and PVCL3_n may be electrically connected to the third power transmission line PVTL3 through a contact hole, and electrically insulated from other power transmission lines.

The third-first power connection line PVCL3_1 may be electrically connected to the first line ML1 of the first display area DA1 through a contact hole, and electrically insulated from other lines. The third-second power connection line PVCL3_2 may be electrically connected to the second line ML2 of the second display area DA2 through a contact hole, and electrically insulated from other lines. The third-(n−1)^{th} power connection line PVCL3_n−1 may be electrically connected to the (n−1)^{th} line MLn−1 of the (n−1)^{th} display area DAn−1 through a contact hole, and electrically insulated from other lines. The third-n^{th} power connection line PVCL3_n may be electrically connected to the n^{th} line MLn of the n^{th} display area DAn through a contact hole, and electrically insulated from other lines.

Accordingly, the third power voltage PV3 may be transmitted to each of the pixels, which are arranged in the first to n^{th} display areas DA1, . . . , and DAn and connected to the first to n^{th} lines ML1, . . . , and MLn, through the third power pad PVP3, the third power pad connection line PPCL3, the third power transmission line PVTL3, and the third-first to third-n^{th} power connection lines PVCL3_1, . . . , and PVCL3_n.

According to an embodiment, the fourth-first to fourth-n^{th} power connection lines PVCL4_1, . . . , and PVCL4_n may electrically connect the fourth power transmission line PVTL4 disposed in the non-display area NDA to the first to n^{th} lines ML1, . . . , and MLn arranged in the first to n^{th} display areas DA1, . . . , and DAn, respectively.

Each of the fourth-first to fourth-n^{th} power connection lines PVCL4_1, . . . , and PVCL4_n may be electrically connected to the fourth power transmission line PVTL4 through a contact hole, and electrically insulated from other power transmission lines.

The fourth-first power connection line PVCL4_1 may be electrically connected to the first line ML1 of the first display area DA1 through a contact hole, and electrically insulated from other lines. The fourth-second power connection line PVCL4_2 may be electrically connected to the second line ML2 of the second display area DA2 through a contact hole, and electrically insulated from other lines. The fourth-(n−1)^{th} power connection line PVCL4_n−1 may be electrically connected to the (n−1)^{th} line MLn−1 of the (n−1)^{th} display area DAn−1 through a contact hole, and electrically insulated from other lines. The fourth-n^{th} power connection line PVCL4_n may be electrically connected to the n^{th} line MLn of the n^{th} display area DAn through a contact hole, and electrically insulated from other lines.

Accordingly, the fourth power voltage PV4 may be transmitted to each of the pixels, which are arranged in the first to n^{th} display areas DA1, . . . , and DAn and connected to the first to n^{th} lines ML1, . . . , and MLn, through the fourth power pad PVP4, the fourth power pad connection line PPCL4, the fourth power transmission line PVTL4, and the fourth-first to fourth-n^{th} power connection lines PVCL4_1, . . . , and PVCL4_n.

According to an embodiment, each of the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_n may extend only to the display area electrically connected to a corresponding power connection line from the power transmission line electrically connected to the corresponding power connection line.

For example, the first-first, second-first, third-first, and fourth-first power connection lines PVCL1_1, PVCL2_1, PVCL3_1, and PVCL4_1 may extend to the first display area DA1 in which the first line ML1 is disposed from the first to fourth power transmission lines PVTL1, PVTL2, PVTL3, and PVTL4, respectively. In a plan view, the first-first, second-first, third-first, and fourth-first power connection lines PVCL1_1, PVCL2_1, PVCL3_1, and PVCL4_1 may overlap the first display area DA1 (i.e., the first line ML1), and may not overlap the second to n^{th} display areas DA2, . . . , and DAn (i.e., the second to n^{th} lines ML2, . . . , and MLn).

For example, the first-second, second-second, third-second, and fourth-second power connection lines PVCL1_2, PVCL2_2, PVCL3_2, and PVCL4_2 may extend to the second display area DA2 in which the second line ML2 is disposed from the first to fourth power transmission lines PVTL1, PVTL2, PVTL3, and PVTL4, respectively. In a plan view, the first-second, second-second, third-second, and fourth-second power connection lines PVCL1_2, PVCL2_2, PVCL3_2, and PVCL4_2 may overlap the first and second display areas DA1 and DA2 (i.e., the first and second lines ML1 and ML2), and may not overlap the third to n^{th} display areas DA3, . . . , and DAn (i.e., the third to n^{th} lines ML3, . . . , and MLn).

For example, the first-(n−1)^{th}, second-(n−1)^{th}, third-(n−1)^{th}, and fourth-(n−1)^{th} power connection lines PVCL1_n−1, PVCL2_n−1, PVCL3_n−1, and PVCL4_n−1 may extend to the (n−1)^{th} display area DAn−1 in which the (n−1)^{th} line MLn−1 is disposed from the first to fourth power transmission lines PVTL1, PVTL2, PVTL3, and PVTL4, respectively. In a plan view, the first-(n−1)^{th}, second-(n−1)^{th}, third-(n−1)^{th}, and fourth-(n−1)^{th} power connection lines PVCL1_n−1, PVCL2_n−1, PVCL3_n−1, and PVCL4_n−1 may overlap the first to (n−1)^{th} display areas DA1, . . . , and DAn−1 (i.e., the first to (n−1)^{th} lines ML1, . . . , and MLn−1), and may not overlap the n^{th} display area DAn (i.e., the n^{th} line MLn).

For example, the first-n^{th}, second-n^{th}, third-n^{th}, and fourth-n^{th} power connection lines PVCL1_n, PVCL2_n, PVCL3_n, and PVCL4_nmay extend to the n^{th} display area DAn in which the n^{th} line MLn is disposed from the first to fourth power transmission lines PVTL1, PVTL2, PVTL3, and PVTL4, respectively. In a plan view, the first-n^{th}, second-n^{th}, third-n^{th}, and fourth-n^{th} power connection lines PVCL1_n, PVCL2_n, PVCL3_n, and PVCL4_nmay overlap the first to n^{th} display areas DA1, . . . , and DAn (i.e., the first to n^{th} lines ML1, . . . , and MLn).

The display panel PNL4 may include dummy patterns DP arranged in the display area DA. The dummy patterns DP may be arranged in an area of the display area DA in which the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_n are not arranged.

The dummy patterns DP may be arranged in the second to n^{th} display areas DA2, . . . , and DAn, respectively, and electrically connected to lines arranged in corresponding display areas through contact holes. In a plan view, the dummy patterns DP overlapping the second display area DA2 may not overlap other display areas, and may be electrically connected to the second line ML2 disposed in the second display area DA2. In a plan view, the dummy patterns DP overlapping the (n−1)^{th} display area DAn−1 may not overlap other display areas, and may be electrically connected to the (n−1)^{th} line MLn−1 disposed in the (n−1)^{th} display area DAn−1. In a plan view, the dummy patterns DP overlapping the n^{th} display area DAn may not overlap other display areas, and may be electrically connected to the n^{th} line MLn disposed in the n^{th} display area DAn.

For example, the dummy patterns DP may be formed through the same process as the first-first to first-n^{th} power connection lines PVCL1_1, . . . , and PVCL1_n, the second-first to second-n^{th} power connection lines PVCL2_1, . . . , and PVCL2_n, the third-first to third-n^{th} power connection lines PVCL3_1, . . . , and PVCL3_n, and the fourth-first to fourth-n^{th} power connection lines PVCL4_1, . . . , and PVCL4_n. The dummy patterns DP may be formed by breaking the first-first to first-(n−1)^{th} power connection lines PVCL1_1, . . . , and PVCL1_n−1, the second-first to second-(n−1)^{th} power connection lines PVCL2_1, . . . , and PVCL2_n−1, the third-first to third-(n−1)^{th} power connection lines PVCL3_1, . . . , and PVCL3_n−1, and the fourth-first to fourth-(n−1)^{th} power connection lines PVCL4_1, . . . , and PVCL4_n−1.

Although one power voltage has been shown in FIG. 11 as being transmitted to each of the first to n^{th} display areas DA1, . . . , and DAn by one power transmission line, the disclosure is not limited thereto. According to an embodiment, the display device DD4 may have a structure that is identical to the structure of each of the display devices DD1 and DD2 described with reference to FIGS. 1 to 6. For example, according to the display panel PNL4, one power voltage may be divided into first to n^{th} power voltages so as to be transmitted to the first to n^{th} display areas DA1, . . . , and DAn, respectively.

The display area DA has been shown in FIGS. 10 and 11 as being partitioned into n areas in a pixel column direction (e.g., the second direction DR2). However, since the above configuration is provided for illustrative purposes, the disclosure is not limited thereto, and the display area DA may be divided in a pixel row direction (e.g., the first direction DR1) and/or the pixel column direction.

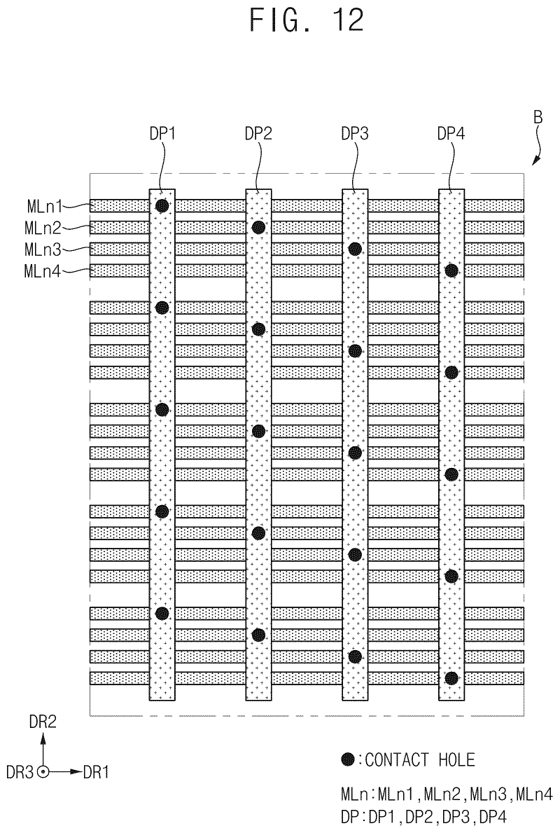

FIG. 12 is an enlarged plan view showing an area B of FIG. 11. Although a portion of an area in which the dummy patterns DP arranged in the n^{th} display area DAn and the n^{th} line MLn are electrically connected has been enlarged and shown in FIG. 12, the following descriptions may be applied to other areas in which the dummy patterns DP and the line are electrically connected in a substantially identical or similar manner.

Referring to FIGS. 10, 11, and 12, each of the first to n^{th} lines ML1, . . . , and MLn may include a plurality of lines. For example, the n^{th} line MLn may include a first voltage line MLn1, a second voltage line MLn2, a third voltage line MLn3, and a fourth voltage line MLn4. Each of the first to fourth voltage lines MLn1, MLn2, MLn3, and MLn4 may extend in the first direction DR1, and may be arranged in a direction that is opposite to the second direction DR2. The first to fourth voltage lines MLn1, MLn2, MLn3, and MLn4 may be repeatedly arranged in the second direction DR2. The first to fourth voltage lines MLn1, MLn2, MLn3, and MLn4 may be spaced apart from each other, and electrically insulated from each other.

The first to fourth voltage lines MLn1, MLn2, MLn3, and MLn4 may receive different voltages, and may be connected to different dummy patterns. For example, the dummy patterns DP may include a first dummy pattern DP1, a second dummy pattern DP2, a third dummy pattern DP3, and a fourth dummy pattern DP4.

For example, the first power voltage PV1 may be provided to the first voltage line MLn1, and the first voltage line MLn1 may be connected to the first dummy pattern DP1 through a contact hole. The second power voltage PV2 may be provided to the second voltage line MLn2, and the second voltage line MLn2 may be connected to the second dummy pattern DP2 through a contact hole. The third power voltage PV3 may be provided to the third voltage line MLn3, and the third voltage line MLn3 may be connected to the third dummy pattern DP3 through a contact hole. The fourth power voltage PV4 may be provided to the fourth voltage line MLn4, and the fourth voltage line MLn4 may be connected to the fourth dummy pattern DP4 through a contact hole.

However, the lines to which the first to fourth dummy patterns DP1, DP2, DP3, and DP4 are connected are not limited. For example, each of the first to fourth dummy patterns DP1, DP2, DP3, and DP4 may be connected to one of the first to fourth voltage lines MLn1, MLn2, MLn3, and MLn4, such as the first dummy pattern DP1 connected to the second voltage line MLn2.

According to the display device DD4 of an embodiment of the disclosure, the display area DA may be divided into a plurality of display areas such that the number of the display areas is greater than or equal to the number of cycle operations of the display panel PNL4, a plurality of power voltages may be provided to each of the display areas, and each of power connection lines configured to provide the power voltages, respectively, may be connected to one of the display areas and electrically insulated from other display areas. Accordingly, upon the cycle operation of the display panel PNL4, an influence of a voltage drop caused by a light emission operation of one display area on other display areas may be minimized, mura that may be visually recognized upon the cycle operation of the display panel PNL4 may be minimized, and display quality of the display device DD4 may be effectively improved.

The display devices DD1, DD2, DD3, and DD4 according to the embodiments of the disclosure may be applied to various electronic devices. An electronic device according to an embodiment of the disclosure may include the display devices DD1, DD2, DD3, and DD4 described above, and may further include a module or a device having other additional functions in addition to the display devices DD1, DD2, DD3, and DD4. The display device according to the embodiment may be applied to various electronic devices. An electronic device in an embodiment includes the above-described display apparatus and may include additional modules or devices having other additional functions in addition to the display device.

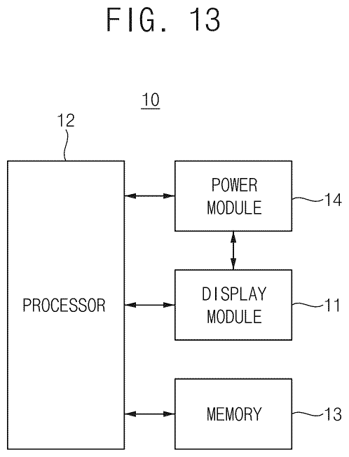

FIG. 13 is a block diagram of an electronic device according to an embodiment.

Referring to FIG. 13, an electronic device 10 according to an embodiment may include a display module 11, a processor 12, a memory 13, and a power module 14.

The processor 12 may include a central processing unit (“CPU”), an application processor (“AP”), a graphic processing unit (“GPU”), a communication processor (“CP”), an image signal processor (“ISP”), and/or a controller.

Data information used for operation of the processor 12 or the display module 11 may be stored in the memory 13. When the processor 12 executes an application stored in the memory 13, an image data signal and/or an input control signal is transmitted to the display module 11, and the display module 11 may process received signal and output image information through a display screen.

The power module 14 may include a power supply module such as a power adapter and/or a battery device, and a power conversion module that converts power supplied by the power supply module to generate power used for operation of the electronic device 10.

At least one of the components of the electronic device 10 described above may be included in the display device according to the above-described embodiments. In addition, some of individual modules functionally included in one module may be included in the display device, and others may be provided separately from the display device. For example, the display device may include the display module 11, and the processor 12, the memory 13, and the power module 14 may be provided in the form of another device in the electronic device 10 other than the display device.

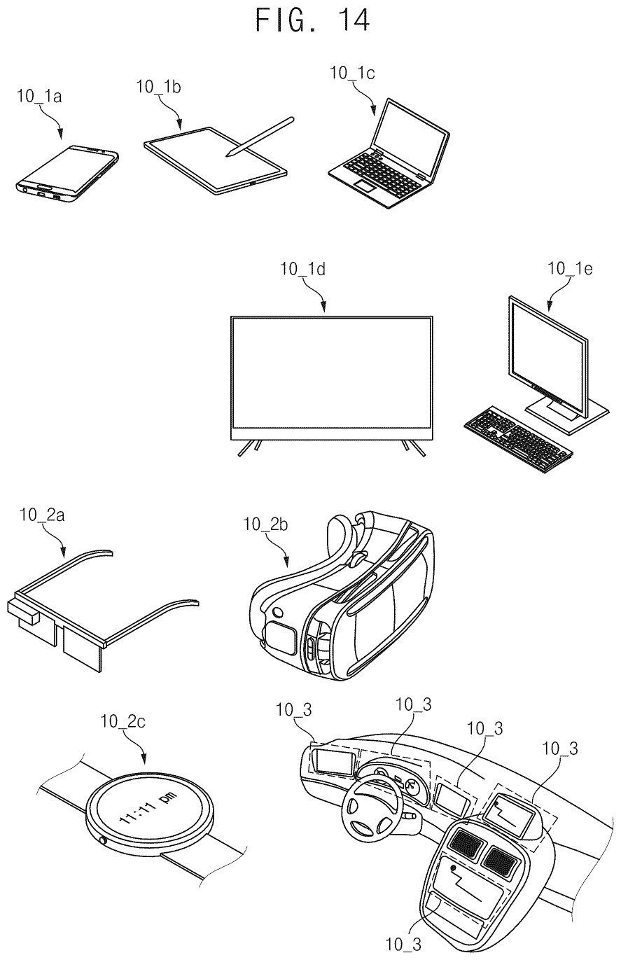

FIG. 14 is a schematic diagram of an electronic device according to various embodiments.

Referring to FIG. 14, one or more suitable electronic devices to which display devices according to an embodiment are applied may include not only electronic devices for image display such as a smartphone 10_1a, a tablet personal computer (“PC”) 10_1b, a laptop 10_1c, a television (“TV”) 10_1d, a desk monitor 10_1e, and/or the like, but wearable electronic devices including display modules such as a smart glass 10_2a, a head mounted display 10_2b, a smart watch 10_2c, and/or the like, vehicle electronic device 10_3 including display modules such as on a vehicle's instrument panel, a center fascia, a center information display (“CID”) located on a dashboard, a room mirror display, and/or the like.

The display device according to the embodiment and the electronic device including the same are explained with reference to the diagram, but the embodiment illustrated is an example, and a person with ordinary knowledge of the relevant technical field understands that the disclosure may be modified and modified in various ways within the scope of the idea and area of the disclosure described in the patent claims below.

What is claimed is:

1. A display device comprising:
a substrate including a plurality of display areas, and a non-display area disposed on an outer side of the display areas;
a first line disposed in a first display area among the display areas, and electrically connected to pixels disposed in the first display area;
a second line disposed in a second display area among the display areas, and electrically connected to pixels disposed in the second display area;
a first power transmission line including
a first-first transmission line disposed on a first side of the non-display area, electrically connected to the first line, and configured to transmit a first power voltage to the first line, and
a first-second transmission line disposed on a second side of the non-display area, electrically connected to the first line, and configured to transmit the first power voltage to the first line; and
a second power transmission line including
a second-first transmission line disposed on the first side of the non-display area, electrically connected to the second line, and configured to transmit a second power voltage to the second line, and
a second-second transmission line disposed on the second side of the non-display area, electrically connected to the second line, and configured to transmit the second power voltage to the second line.

2. The display device of claim 1, further comprising:
a first connection line electrically connecting the first-first transmission line, the first-second transmission line, and the first line; and
a second connection line electrically connecting the second-first transmission line, the second-second transmission line, and the second line.

3. The display device of claim 2, wherein each of the first connection line and the second connection line overlaps the first display area and the second display area in a plan view.

4. The display device of claim 2, wherein the first connection line is electrically insulated from each of the second line and the second power transmission line, and
the second connection line is electrically insulated from each of the first line and the first power transmission line.

5. The display device of claim 2, wherein the first connection line extends from the first-first transmission line to the first-second transmission line, and
the second connection line extends from the second-first transmission line to the second-second transmission line.

6. The display device of claim 2, wherein each of the first line and the second line extends in a first direction,
the second display area is located in a second direction, which intersects the first direction, from the first display area, and
each of the first connection line and the second connection line extends in the second direction.

7. The display device of claim 6, wherein each of the first-first transmission line, the first-second transmission line, the second-first transmission line, and the second-second transmission line extends in the first direction.

8. The display device of claim 1, wherein the first power voltage and the second power voltage are a same power voltage.

9. The display device of claim 1, wherein the first power voltage and the second power voltage are different from each other.

10. The display device of claim 1, wherein each of the first-first transmission line and the first-second transmission line is further electrically connected to the second line, and configured to transmit the first power voltage to the second line, and
each of the second-first transmission line and the second-second transmission line is further electrically connected to the first line, and configured to transmit the second power voltage to the first line.

11. The display device of claim 10, further comprising:
a first-first power connection line electrically connecting the first-first transmission line, the first-second transmission line, and the first line;
a first-second power connection line electrically connecting the first-first transmission line, the first-second transmission line, and the second line;
a second-first power connection line electrically connecting the second-first transmission line, the second-second transmission line, and the first line; and
a second-second power connection line electrically connecting the second-first transmission line, the second-second transmission line, and the second line.

12. The display device of claim 11, wherein each of the first-first power connection line, the first-second power connection line, the second-first power connection line, and the second-second power connection line overlaps the first display area and the second display area in a plan view.

13. The display device of claim 11, wherein the first-first power connection line is electrically insulated from each of the second line and the second power transmission line,
the first-second power connection line is electrically insulated from each of the first line and the second power transmission line,
the second-first power connection line is electrically insulated from each of the second line and the first power transmission line,
the second-second power connection line is electrically insulated from each of the first line and the first power transmission line.

14. The display device of claim 11, wherein each of the first-first power connection line and the first-second power connection line extends from the first-first transmission line to the first-second transmission line, and
each of the second-first power connection line and the second-second power connection line extends from the second-first transmission line to the second-second transmission line.

15. The display device of claim 11, wherein each of the first line and the second line extends in a first direction,
the second display area is located in a second direction, which intersects the first direction, from the first display area, and
each of the first-first power connection line, the first-second power connection line, the second-first power connection line, and the second-second power connection line extends in the second direction.

16. The display device of claim 10, wherein the first power voltage and the second power voltage are different power voltages.

17. The display device of claim 10, further comprising:
a display panel including the display areas,
wherein a number of the display areas is greater than or equal to a number of cycle operations of the display panel, and the number of cycle operations is a number of light emission operations of the display panel per image frame.

18. The display device of claim 1, wherein each of the first power transmission line and the second power transmission line surrounds the display areas in a plan view.

19. The display device of claim 1, wherein the first power transmission line and the second power transmission line are electrically insulated from each other.

20. An electronic device comprising:
a display device; and
a power module, which supplies power to the display device,
wherein the display device comprises:
a substrate including a plurality of display areas, and a non-display area disposed on an outer side of the display areas;
a first line disposed in a first display area among the display areas, and electrically connected to pixels disposed in the first display area;
a second line disposed in a second display area among the display areas, and electrically connected to pixels disposed in the second display area;
a first power transmission line including
a first-first transmission line disposed on a first side of the non-display area, electrically connected to the first line, and configured to transmit a first power voltage to the first line, and
a first-second transmission line disposed on a second side of the non-display area, electrically connected to the first line, and configured to transmit the first power voltage to the first line; and
a second power transmission line including
a second-first transmission line disposed on the first side of the non-display area, electrically connected to the second line, and configured to transmit a second power voltage to the second line, and
a second-second transmission line disposed on the second side of the non-display area, electrically connected to the second line, and configured to transmit the second power voltage to the second line.
